(19) United States
(12) Patent Application Publication
(10) Pub. No.: US 2005/0260404 A1
(43) Pub. Date: Nov. 24, 2005

(54) Sheet-form molding

(76) Inventors: Tetsunari Iwade, Hasuda, Saitama (JP); Koichi Shibayama, Mishima-gun, Osaka (JP); Hideyuki Takahashi, Mishima-gun, Osaka (JP); Koji Taniguchi, Mishima-gun, Osaka (JP); Hiroshi Murayama, Amagaski-shi, Hyogo (JP); Tetsuya Kusano, Mishima-gun, Osaka (JP); Akihiko Bandou, Mishima-gun, Osaka (JP)

Correspondence Address: SUGHRUE MION, PLLC, 2100 PENNSYLVANIA AVENUE, N.W., SUITE 800, WASHINGTON, DC, 20037, US

(21) Appl. No.: 10/362,282

(22) PCT Filed: Aug. 27, 2001
(86) PCT No.: PCT/JP01/07296

§ 371 Date: Apr. 23, 2003

(30) Foreign Application Priority Data
Aug. 25, 2000 (JP) 2000-255936
Jan. 9, 2001 (JP) 2001-1582
Apr. 11, 2001 (JP) 2001-113181
Apr. 23, 2001 (JP) 2001-124764

(51) Int. Cl. B32B 5/00

(52) U.S. Cl. 428/325; 428/343

(57) ABSTRACT

There is provided a sheet-form molding which is outstanding in fire retardation and prevention of flame spread, exhibiting good fire retardant and flame spread-preventive effects based on its good form retention during combustion, and also outstanding in mechanical strength and stability, particularly with a reduced incidence of necking and shrinkage, thus insuring high dimensional accuracy in use and precision in application. Particularly, there is provided a sheet-form molding comprising a single layer or a plurality of layers, which has at least one layer consisting essentially of formulating 0.1 to 100 weight parts of a lamellar silicate, and 0.1 to 70 weight parts of a metal hydroxide and/or 0.1 to 50 weight parts of a melamine derivative in each 100 weight parts of a thermoplastic resin.

### TECHNICAL FIELD

The present invention relates to a sheet-form molding which is not only outstanding in fire retardation and flame spread prevention characteristics, exhibiting good fire retardant and flame spread-arresting effects particularly on account of its excellent form retentivity during combustion, but also outstanding in mechanical strength and stability, particularly with a reduced incidence of necking and shrinkage, thus insuring high dimensional accuracy in use and precision of application.

### BACKGROUND ART

While sheet-form molding finds application in a variety of fields, such as tape bases, films, and sheets, they are required to meet various quality requirements, which depend on the respective uses.

Decorative sheet materials, for instance, are generally required to have an opacifying power for hiding the underlying surface, a satisfactory application workability, and a fire retardancy for preventing the flame spread via the decorative sheet in the event of a fire. Therefore, flexible polyvinyl chloride resins have heretofore been used as materials for fire-retardant decorative sheets.

Similarly, ornamental pressure-sensitive adhesive sheets, alias pressure-sensitive adhesive sheets for decorating, are also required to have fire retardance as well as flexibility (application workability) and permeability, and flexible polyvinyl chloride resins have so far been utilized.

On the other hand, in the field of high polymer materials for industrial application, the recent problems with the disposal of waste plastics and the risk for environmental pollutions due to the so-called environmental hormone have given impetus to substitution with the so-called ecofriendly materials. Thus, spurred, for example, by the problems associated with the generation of dioxin on combustion and the toxicity of plasticizers, which are the common additives to flexible polyvinyl chloride resins, a switch-over to polyolefin resins is contemplated.

Therefore, in the field of sheet materials, too, attempts to make a switch-over to ecofriendly materials which, when combusted, would impose only a limited burden on the environment have been undertaken in recent years as epitomized by the development of polyolefin resin decorative sheets disclosed in Japanese Kokai Publication Hei-8-3380 and Japanese Kokai Publication Hei-8-1897.

However, polyolefin resin is one of the most combustible resins and, therefore, it is a difficult task to materialize fire retardancy. In order to materialize fire retardancy in polyolefin resins, it is common practice to incorporate fire retardant additives in polyolefin resins at high concentration levels.

Among such fire retardant additives, those comprising halogen-containing compounds are highly fire-retardant and not detracting much from moldability or mechanical strength of moldings such as decorative sheets but since these additives generate large amounts of halogen gases during molding or on combustion with the consequent risk for causing corrosion of equipment or adversely affecting human health, there is a standing demand for a non-halogen fire retardation technology which might dispense with the need for halogen-containing compounds from safety considerations.

As an example of such non-halogen fire retardation technology for polyolefin resins, the methodology comprising addition of a metal compound, such as aluminum hydroxide, magnesium hydroxide or basic magnesium carbonate, which does not entail evolution of harmful gases on combustion has been proposed in, inter alia, Japanese Kokai Publication Sho-57-165437 and Japanese Kokai Publication Sho-61-36343.

However, it requires addition of such a metal compound in large amounts to invest sufficient fire retardancy in otherwise easily combustible polyolefin resins but such a practice entails marked reductions in mechanical strength of molded articles or interferes with molding of the resin material into the film or sheet form, thus presenting the problem that the technology can hardly be implemented commercially.

Particularly in cases where a metal hydroxide, such as aluminum hydroxide or magnesium hydroxide, is added to a polyolefin resin, the resulting composition cannot form an integral case layer on combustion but rather leaves a fragile ashes exposed to cause exfoliation of combustion residues, thus leading to an early loss of the heat barrier function and a failure to arrest the flame spread caused by deformation of the material.

Meanwhile, there has been proposed a technology, which comprises adding a phosphorus type fire retardant additive to a polyolefin resin to let it form a cover film on combustion and a fire retardant effect be expressed on the strength of the oxygen-impermeability feature of the film. However, in order to invest sufficient fire retardancy to a polyolefin resin, it is essential to add a phosphorus type fire retardant in large amounts but the practice entails a marked reduction in mechanical strength of the molded product, thus causing the technique to be practically inapplicable. Furthermore, in cases where a phosphorus type fire retardant additive is added to a polyolefin resin, a tough integral layer can hardly be obtained, although localized cover films may actually be formed. Moreover, the mechanical strength of such local films is so low that easily fragile ashes are exposed to cause exfoliation of combustion residues, thus leading to an early loss of the heat barrier function and a failure to arrest the flame spread caused by deformation of the material.

Meanwhile, Japanese Kokai Publication Hei-6-25476 discloses a resin composition comprising a polyolefin resin supplemented with either red phosphorus or phosphorus compound and expanded graphite. This resin composition has sufficient fire retardancy in terms of oxygen index but in actualities may form a cover film only locally without formation of a tough integral casing. Moreover, the mechanical strength of the local cover film is so low that, in combustion, it leaves fragile ashes exposed to cause exfoliation of combustion residues, with the result that, here again, an early loss of the heat barrier function and a failure to arrest the flame spread caused by deformation of the material are inevitable. Furthermore, when such a fire-retardant composition is to be used for the production of fire-retardant polyolefin resin sheets, the fire retardant additive must be formulated at a high addition level so that it is difficult to provide for flexibility and elongation, which are the physical properties required of sheet materials.

As a non-halogen fire retardation technique, the possibility of incorporating plate-shaped talc has also been explored as in Japanese Kokai Publication Hei-6-41371. However, just like the fire retardation technique described above, this technique requires a high level of addition, i.e. 80 to 130 weight parts relative to the base resin, so that when applied to raw materials for decorative sheets or ornamental pressure-sensitive adhesive sheets, the technique has the drawback that it can hardly provide for flexibility and elongation which are physical properties of great importance.

Regarding the masking tape for plating which is used for masking (protecting) the non-plate area in the plating of lead frame metal plates with which electronic parts are equipped, which is another field of application of sheet-form molding, it is common practice to use a tape comprising a base or substrate layer of polyolefin resin, e.g. polyethylene or polypropylene, and, as disposed on one face thereof, a pressure-sensitive adhesive layer as disclosed in Japanese Kokai Publication Hei-7-3490, Japanese Kokai Publication Hei-11-172488, etc.

However, in line with the constant down-sizing of electronic devices such as transistors, the wiring pattern width of LSI and other integrated-circuit components has steadily become narrower in recent years. Therefore, particularly in the production of plating stripes, there is a demand for improved dimensional accuracy of the plate and non-plate areas.

Generally in the step of applying a masking tape for plating, the tape is paid out from a roll, slit in the dimensional accuracy of the non-plating area, and applied to the frame stripe material. Since the tape is subject to a tensile force during this operation, an elongation due to creep occurs in the course immediately following slitting to application of the tape to the frame stripe so that a reduction in slit width or a variation in slit width reflecting the change in tension takes place. Such misregistration with the plating area and non-plating area causes the unfavorable phenomenon that the area not to be plated is plated or conversely the area, which must be plated is not plated.

In case the above phenomenon occurs, a short-circuit takes place between the adjacent conductor patterns so that the end-product obtainable upon after-processing of the lead frame metal sheet tends to develop an erratic operation.

In order to prevent such troubles, it is necessary to improve the dimensional accuracy of the masking tape for plating and the substrate or base layer for forming the masking tape for plating is required to have a low compliance, that is to say a high elastic modulus.

### SUMMARY OF INVENTION

In the light of the above state of the art, the present invention has for its object to provide a sheet-form molding which is not only outstanding in fire retardation and prevention of flame spread, exhibiting good fire retardant and flame spread-preventive effects particularly on account of its good form retention in combustion, but also outstanding in mechanical strength and stability, particularly with a reduced incidence of necking and shrinkage, thus insuring high dimensional accuracy in use and precision in application.

The first aspect of the present invention is concerned with a sheet-form molding comprising a single layer or a plurality of layers, which has at least one layer constructed by formulating 0.1 to 100 weight parts of a lamellar silicate, and 0.1 to 70 weight parts of a metal hydroxide and/or 0.1 to 50 weight parts of a melamine derivative in each 100 weight parts of a thermoplastic resin.

The thermoplastic resin mentioned above is preferably a polyolefin resin and the polyolefin resin mentioned above is more preferably at least one polyolefin resin selected from the group comprising a homopolymer of ethylene, a copolymer of ethylene and an α-olefin other than ethylene and copolymerizable with the ethylene, an ethylene-ethyl acrylate copolymer, an ethylene-vinyl acetate copolymer, a homopolymer of propylene, a copolymer of propylene and an α-olefin other than propylene and copolymerizable with the propylene, and a polypropylene alloy resin. More preferably, the polypropylene alloy resin mentioned above is predominantly composed of a polypropylene resin such that, of the total elution amount in cross fractionation chromatography, the elution amount at temperatures not over 10° C. accounts for 30 to 80 weight % and the elution amount at temperatures over 10° C. up to 70° C. accounts for 5 to 35 weight %. The thermoplastic resin composition comprising 0.1 to 100 weight parts of a lamellar silicate, and 0.1 to 70 weight parts of a metal hydroxide and/or 0.1 to 50 weight parts of a melamine derivative in each 100 weight parts of said polypropylene alloy resin also constitutes one of this invention.

The lamellar silicate mentioned above is preferably montmorillonite and/or swellable mica. Moreover, preferably the lamellar silicate comprises an alkylammonium ion containing not less than 6 carbon atoms, furthermore, the lamellar silicate is such that the mean interlayer distance in the (001) plane as measured by wide-angle X-ray diffractometry is not less than 3 nm and that it has been partially or totally dispersed as s dispersoid comprising not more than 5 layers.

The sheet-form molding according to this first aspect of the invention is preferably when, in a combustion test according to ASTM E 1354, it is combusted by heating under a radiant heating condition of 50 kW/m² for 30 minutes and combustion residues are compressed at a rate of 0.1 cm/s, the yield stress is not less than 4.9 kPa.

The second aspect of the present invention is concerned with a sheet-form molding when it is laminated with a non-combustible material and combusted under a radiant heating condition of 50 kW/m² in accordance with ISO 1182, the time in which the maximum exotherm rate is continuously not less than 200 kW/m² during a 20-minute period immediately following the start of heating is less than 10 seconds and the total exotherm amount is not over 8 MJ/m², and that it has a thickness of not less than 20 μm. The sheet-form molding according to this second aspect of the invention is preferably the mean standstill time of mice is not less than 6.8 minutes in a gas toxicity test in accordance with ISO 1182.

Preferably the sheet-form molding according to the first or the second aspect of the invention has a density of 0.90 to 1.20 g/cm³.

The sheet-form molding according to the first or the second aspect of the invention in which at least one layer thereof is an adhesive/pressure-sensitive adhesive layer is an embodiment of the invention. Furthermore, the sheet-form molding according to the first or the second invention, which has a pigmented layer and a transparent layer in addition to said adhesive/pressure-sensitive adhesive layer also constitutes another embodiment of the invention. Moreover, a multi-layer sheet-form molding, which contains 0.1 to 100 weight parts of a lamellar silicate in each 100 weight parts of said thermoplastic resin in addition to said adhesive/pressure-sensitive adhesive layer is also an embodiment of the invention.

The third aspect of the invention is concerned with a decorative sheet comprising the sheet-form molding of the first or the second aspect of the invention. Preferably the decorative sheet according to this third aspect of the invention, which comprises a laminate comprising, reckoning from the face layer side, a transparent film layer, a printed layer, a pigmented film layer, and an adhesive/pressure-sensitive adhesive layer in the order mentioned and is preferably a sheet having elongation after fracture of which is not less than 80% and 2% modulus value of which is 2 to 40 N/10 mm.

The fourth aspect of the present invention is concerned with an ornamental pressure-sensitive adhesive sheet, which comprises the sheet-form molding according to the first or the second aspect of the invention. Preferably the ornamental pressure-sensitive adhesive tape according to the fourth aspect of the present invention, which comprises a laminate comprising, reckoning from the face layer side, a transparent or pigmented transparent film, a pigmented film, and an adhesive/pressure-sensitive adhesive layer in the order mentioned, and is preferably a film having elongation after fracture of which is not less than 80% and 2% modulus value of which is 2 to 40 N/10 mm.

The decorative sheet according to the third aspect of the invention and the ornamental pressure-sensitive adhesive tape according to the fourth aspect of the invention are preferably molded by a calendermolding technique and these preferably the surface of a fire retardant additive is coated with a calendering auxiliary agent.

The fifth aspect of the present invention is concerned with a tape, which comprises the sheet-form molding according to the first or the second aspect of the invention.

The six aspect of the present invention is concerned with a tape comprising a tape base consisting in a single layer or of a plurality of layers, wherein the tape base having a layer or layers containing 0.1 to 100 weight parts of a lamellar silicate in each 100 weight parts of a thermoplastic resin and the lamellar silicate is such that the mean interlayer distance in the (001) plane as measured by wide-angle X-ray diffractometry is not less than 3 nm and that it has been partially or totally dispersed as a dispersoid comprising not more than 5 layers. The thermoplastic resin mentioned just above is preferably a polyolefin resin which is preferably at least one polyolefin resin selected from the group consisting of a homopolymer of ethylene, a copolymer of ethylene and an α-olefin other than ethylene and copolymerizable with the ethylene, an ethylene-ethyl acrylate copolymer, an ethylene-vinyl acetate copolymer, a homopolymer of propylene, a copolymer of propylene and an α-olefin other than propylene and copolymerizable with the propylene, and a polypropylene alloy resin. Moreover, the lamellar silicate mentioned above is preferably montmorillonite and/or swellable mica, and preferably contains an alkylammonium ion containing not less than 6 carbon atoms.

The tape according to the sixth aspect of the invention is preferably when, in a combustion test according to ASTM E 1354, it is combusted by heating under a radiant heating condition of 50 kW/m² for 30 minutes and combustion residues are compressed at a rate of 0.1 cm/s, the yield stress is not less than 4.9 kPa. Moreover, the tape according to the sixth aspect of the invention preferably has a density of 0.90 to 1.20 g/cm³.

The tape according to the fifth or the sixth aspect of the invention is preferably such that as determined according to JIS K 7113, the tensile stress at 5% strain is not less than 39.2 N/mm² or the tensile modulus of elastisity is not less than 784.0 N/mm².

The seventh aspect of the present invention is concerned with a protect tape, which comprises the tape according to the fifth or the sixth aspect of the invention.

The eighth aspect of the present invention is concerned with a masking tape for plating, which comprises the tape according to the fifth or the sixth aspect of the invention.

### DETAILED DISCLOSURE OF THE INVENTION

The present invention is now described in detail.

The sheet-form molding according to the first aspect of the invention is a single-layer or a plurality of layers artifact which has at least one layer containing 0.1 to 100 weight parts of a lamellar silicate, and 0.1 to 70 weight parts of a metal hydroxide and/or 0.1 to 50 weight parts of a melamine derivative in each 100 weight parts of a thermoplastic resin.

The thermoplastic resin mentioned above is not particularly restricted but includes, inter alia, polyolefin resins, polystyrene resins, polyester resins, polyamide resins, polyvinyl acetal resins, polyvinyl alcohol resins, polyvinyl acetate resins, poly(meth)acrylic ester resins, norbornene resins, polyphenylene ether resins, and polyoxymethylene resins. Among these, polyolefin resins are used with advantage. These thermoplastic resins can be used each independently or in a combination of two or more species.

It should be understood that, as used in this description, the term “(meth)acryl” means both acryl and methacryl.

The term “polyolefin resin” used above means any and all resins resulting from the homopolymerization or copolymerization of olefinic monomers containing a polymerizable double bond within the molecule.

The olefinic monomer referred to just above is not particularly restricted but includes, inter alia, α-olefins, such as ethylene, propylene, 1-butene, 1-pentene, 1-hexene, 1-heptene, 1-octene, 4-methyl-1-pentene, vinyl acetate, etc.; and conjugated dienes, such as butadiene and isoprene, among others. These olefinic monomers can be used each independently or in a combination of two or more species.

The polyolefin resin mentioned above is not particularly restricted but includes, inter alia, a homopolymer of ethylene; a copolymer of ethylene and an α-olefin other than ethylene and copolymerizable with the ethylene; an ethylene-(meth)acrylic acid and/or (meth)acrylate (e.g. ethyl(meth)acrylate) copolymer; an ethylene-vinyl acetate copolymer; a polyethylene resin such as an ethylene-styrene copolymer; a homopolymer of propylene; a copolymer of propylene and an α-olefin other than propylene and copolymerizable with the propylene; a propylene-ethylene random copolymer or block copolymer; a polypropylene resin such as a polypropylene alloy resin; a homopolymer of butene; a homopolymer or copolymer of a conjugated diene such as butadiene, isoprene, or the like. Particularly preferred is at least one kind of polyolefin resin selected from the group consisting of a homopolymer of ethylene, a copolymer of ethylene and an α-olefin other than ethylene and copplymerizable with ethylene, an ethylene-ethyl acrylate copolymer, an ethylene-vinyl acetate copolymer, a homopolymer of propylene, a copolymer of propylene and an α-olefin other than propylene and copolymerizable with propylene, and a polypropylene alloy resin. These polyolefin resins can be used each independently or in a combination of two or more species.

As the (meth)acrylic acid and (meth)acrylic ester which can be copolymerized with said olefinic monomer, there can be mentioned compounds represented by the following general formula.
CH₂═C(R¹)COO—R²
wherein R¹ represents hydrogen or methyl group; R² represents hydrogen or a univalent group selected from the group consisting of aliphatic hydrocarbon groups, aromatic hydrocarbon groups, and hydrocarbon groups containing at least one functional group such as halogen, amino, glycidyl, or the like.

The (meth)acrylic ester represented by the above general formula is not particularly restricted but includes, inter alia, methyl(meth)acrylate, ethyl(meth)acrylate, n-propyl(meth)acrylate, isopropyl(meth)acrylate, n-butyl(meth)acrylate, isobutyl(meth)acrylate, sec-butyl(meth)acrylate, t-butyl(meth)acrylate, isoamyl(meth)acrylate, n-hexyl(meth)acrylate, cyclohexyl(meth)acrylate, 2-ethylhexyl(meth)acrylate, n-octyl(meth)acrylate, lauryl(meth)acrylate, n-tridecyl(meth)acrylate, myristyl(meth)acrylate, cetyl(meth)acrylate, stearyl(meth)acrylate, allyl(meth)acrylate, vinyl(meth)acrylate, benzyl(meth)acrylate, phenyl(meth)acrylate, 2-naphthyl(meth)acrylate, 2,4,6-trichlorophenyl(meth)acrylate, 2,4,6-tribromophenyl(meth)acrylate, isobornyl(meth)acrylate, 2-methoxyethyl(meth)acrylate, 2-ethoxyethyl(meth)acrylate, diethylene glycol(meth)acrylate monomethyl ether, polyethylene glycol(meth)acrylate monomethyl ether, polypropylene glycol(meth)acrylate monomethyl ether, tetrahydrofurfuryl(meth)acrylate, 2,3-dibromopropyl(meth)acrylate, 2-chloroethyl(meth)acrylate, 2,2,2-trifluoroethyl(meth)acrylate, hexafluoroisopropyl(meth)acrylate, glycidyl(meth)acrylate, 3-trimethoxysilylpropyl(meth)acrylate, 2-diethylaminoethyl(meth)acrylate, 2-dimethylaminoethyl(meth)acrylate and t-butylaminoethyl(meth)acrylate. These (meth)acrylic esters can be used each independently or in a combination of two or more species.

The (meth)acrylic acid and/or (meth)acrylic ester or vinyl acetate content of said copolymer of ethylene and (meth)acrylic acid and/or an ester thereof or said ethylene-vinyl acetate copolymer can be judiciously selected according to the performance characteristics required of the objective sheet-form molding and is not particularly restricted; usually, however, it preferably accounts for 0.1 to 50 weight %. If it is less than 0.1 weight %, the improving effect on the flexibility of sheet-form molding tends to be inadequate. If it exceeds 50 weight %, the heat resistance of the sheet-form molding tends to be decreased. The more preferred content is 5 to 30 weight %.

In cases where a highly flexible polyolefin resin is required, a copolymer of ethylene and an α-olefin other than ethylene is generally used. Particularly, an increased α-olefin content results in improved flexibility and such a copolymer is suitable for a sheet required to have flexibility. The above-mentioned α-olefin other than ethylene is not particularly restricted but, to mention a few examples, propylene, 1-butene, 1-hexene, 4-methyl-1-pentene and 1-octene can be used with advantage. These α-olefins other than ethylene may be used each independently or in a combination of two or more species.

In the above copolymer of ethylene and an α-olefin other than ethylene, the α-olefin content exclusive of ethylene is not particularly restricted but is preferably 0.1 to 50 weight %. If it is less than 0.1 weight %, no sufficient flexibility may be obtained. If it exceeds 50 weight %, heat resistance tends to be decreased. The more preferred content is 2 to 40 weight %.

The above-mentioned copolymer of ethylene and an α-olefin other than ethylene can be prepared by a polymerization technique using a complex compound of a Group IV, X or XI transition metal as the polymerization catalyst. The transition metal complex referred to above is a complex consisting of the particular transition metal atom and a ligand.

The ligand is not particularly restricted but includes, inter alia, a cyclopentadiene ring substituted by e.g. a hydrocarbon group, a substituted hydrocarbon group or a hydrocarbon-substituted metaloid group; a cyclopentadienyl oligomer ring; an indenyl ring; an indenyl ring substituted by e.g. a hydrocarbon group, a substituted hydrocarbon group, or a hydrocarbon-substituted metaloid group; a univalent anion ligand such as chloro or bromo; a bivalent anion chelate ligand; a hydrocarbon group; alkoxide; arylamido; aryloxide; amido; phosphido; arylphosphido; silyl group; and substituted silyl group; among others. These ligands may be used each independently or in a combination of two or more species.

The hydrocarbon group mentioned just above is not particularly restricted but includes methyl group, ethyl group, propyl group, butyl group, amyl group, isoamyl group, hexyl group, isobutyl group, heptyl group, octyl group, nonyl group, decyl group, cetyl group, 2-ethylhexyl group, and phenyl group, among others. These hydrocarbon groups may be used each independently or in a combination of two or more species.

Referring to specific transition metal complexes having those ligands, which are not particularly restricted, the following complexes may be mentioned by way of illustration. As complexes of Group IV transition metals, there can be mentioned cyclopentadienyltitanium tris(dimethylamide), methylcyclopentadienyltitanium tris(dimethylamide), bis(cyclopentadienyl)titanium dichloride, dimethylsilyltetramethylcyclopentadienyl-t-butylamidozirconium dichloride, dimethylsilyltetramethylcyclopentadienyl-t-butylamidohafnium dichloride, dimethylsilyltetramethylcyclopentadienyl-p-n-butylphenylamidozirconium chloirde, methylphenylsilyltetramethylcyclopentadienyl-t-butylamidohafnium dichloride, indenyltitanium tris(di-n-propylamide), indenyltitanium bis(di-n-butylamido)(di-n-propylamide), etc.; and as complexes of Group X or XI transition metals, such as nickel, palladium, copper, and silver, there can be mentioned complexes having the following ligands: bipyridine, substituted bipyridine, bisoxazoline, substituted bisoxazoline; ligands represented by the general formula ArN═CR³CR⁴═NAr (where Ar represents an aryl group such as phenyl group or substituted phenyl group; R³ and R⁴ each represents hydrogen, halogen, alkyl group, or aryl group, or R³ and R⁴, taken together, represent a cyclic hydrocarbon group); various diimines; N,N′-dimethylamidinato, N,N′-diethylamidinato, N,N′-diisopropylamidinato, N,N′-di-t-butylamidinato, N,N′-trifluoromethylamidinato, N,N′-diphenylamidinato, N,N′-di-substituted phenylamidinato, N,N′-ditrimethylsilylamidinato, N,N′-dimethylbenzamidinato, N,N′-diethylbenzamidinato, N,N′-diisopropylbenzamidinato, N,N′-di-t-butylbenzamidinato, N,N′-trifluoromethylbenzamidinato, N,N′-diphenylbenzamidinato, N,N′-ditrimethylsilylbenzamidinato; N,N′-di-substituted phenylbenzamidinato; and so forth. These transition metal complexes may be used each independently or in a combination of two or more species. The above transition metal complexes can be generally obtained in the presence of a Lewis acid such as an organoaluminum compound or a boron compound.

The copolymer of ethylene and an α-olefin other than ethylene as obtainable by the polymerization in the presence of such a catalyst system can be increased in the α-olefin content exclusive of ethylene or its compositional distribution can be freely controlled, with the result that it can be used with advantage as a raw material for the sheet-form molding according to the first aspect of the invention which may meet the flexibility and mechanical strength requirements within a broad range.

When a polyolefin resin having still higher flexibility is required, a polyolefin alloy resin containing a polyolefin resin as a dominant component and, as finely dispersed therein, an elastomer (rubber) component can be employed.

The technology of dispersing an elastomer as the rubber component in finely divided state in the dominant component polyolefin resin is not particularly restricted but includes the method which comprises adding the elastomer component to the molten polyolefin resin and co-kneading them uniformly and the method which comprises adding the elastomer component to a polymerization system for the polyolefin resin to carry out the production of the polyolefin resin and the microscopic dispersion of the elastomer component concurrently, among others, although the latter method is preferred because a polyolefin alloy resin containing the elastomer component dispersed uniformly in a highly micronized state can be obtained.

By using a polyolefin alloy resin containing the rubber component elastomer dispersed in micronized state, the resulting thermoplastic resin composition is allowed to express excellent flexibility and elongation properties without being compromised in other physical characteristics.

For the reason that a thermoplastic resin composition expressing still more improved flexibility and elongation characteristics can be obtained, the particularly preferred resins among the above-mentioned polyolefin alloy resins are a polypropylene alloy resin comprising any of the following polypropylene resin as a dominant component and an elastomer component finely dispersed therein: a homopolymer of propylene, a copolymer of propylene and an α-olefin other than propylene and copolymerizable with propylene, and a propylene-ethylene random or block copolymer.

Among the above polypropylene alloy resins, the polypropylene alloy resin composed predominantly of a polypropylene resin such that, of the total elution amount in cross-fractional chromatography, the elution amount at temperatures not over 10° C. accounts for 30 to 80 weight % and the elution amout at temperatures over 10° C. up to 70° C. accounts for 5 to 35 weight % is still more preferred.

The above temperature-dependent difference in the elution amount in cross-fractional chromatography reflects, for the most part, the difference in the crystallinity of polypropylene resin. Thus, the polypropylene resin showing the above elution pattern is a resin having a broad distribution of crystallinity and the polypropylene alloy resin composed predominantly of this particular polypropylene resin expresses good flexibility and elongation without showing any material decreases in physical properties even when loaded with the lamellar silicate and fire retardant additive to be described hereinafter at a high loading rate.

The method of measuring the above-mentioned elution amount in cross-fractional chromatography is not particularly restricted but may for example be the following method. Thus, the polypropylene resin is first dissolved in a solvent, such as o-dichlorobenzene, at a temperature where the polypropylene resin is thoroughly soluble and the resulting solution is cooled at a constant rate to deposit the polypropylene resin in a thin layer on the surface of an inert support prepared in advance in the descending order of crystallinity and descending order of molecular weight. Then, in accordance with a temperature-incremental fractionation program, the temperature is increased either continuously or stepwise and the concentrations of the fractions serially eluted in predetermined temperature steps are detected to find the compositional distribution (crystallinity profile). At the same time, the molecular weights of the respective fractions and the molecular weight distribution are determined by high-temperature GPC.

If the elution amount at temperatures not over 10° C. is less than 30 weight % of the total elution amount in said cross-fractional chromatography, the polypropylene resin will be deficient in flexibility, with the result that the polypropylene alloy resin based on this polypropylene resin may not be sufficiently loaded with said lamellar silicate and fire retardant additive. If the elution amount at temperatures not over 10° C. exceeds 80 weight %, the polypropylene resin will be so excessively flexible that the sheet-form molding according to the first aspect of the invention which is made from the polypropylene alloy resin composed predominantly of this polypropylene resin tends to be inadequate in mechanical strength.

If the elution amount at temperatures over 10° C. up to 70° C. accounts for only less than 5 weight % of the total elution amount in cross-fractional chromatography, the heat resistance of the polypropylene resin will not be sufficiently high, with the result that the sheet-form molding according to the first aspect of the invention as fabricated using the propylene alloy resin composed predominantly of this polypropylene resin tends to be deficient in heat resistance. If said elution amount exceeds 35 weight %, the flexibility of the polypropylene resin will be insufficient and, hence, the polypropylene alloy resin composed predominantly of this polypropylene resin tends to become hardly loadable with said lamellar silicate and fire retardant additive at a sufficient high loading rate.

A thermoplastic resin composition containing 0.1 to 100 weight parts of a lamellar silicate and 0.1 to 70 weight parts of a metal hydroxide and/or 0.1 to 50 weight parts of a melamine derivative in each 100 weight parts of the above polypropylene alloy resin which is predominantly composed of a polypropylene resin such that, of the total elution amount in cross-fractional chromatography, the elution amount at temperatures not over 10° C. accounts for 30 to 80 weight % and the elution amount at temperatures over 10° C. up to 70° C. accounts for 5 to 35 weight % is also another embodiment of the invention.

The molecular weight and molecular weight distribution of the thermoplastic resin for use in the invention are not particularly restricted but the weight average molecular weight of the thermoplastic resin is preferably 5,000 to 5,000,000, more preferably 20,000 to 300,000 and the molecular weight distribution in terms of weight average molecular weight/number average molecular weight is preferably 1.1 to 80, more preferably 1.5 to 40.

Where necessary but within the range not interfering with accomplishment of the object of the invention, thermoplastic elastomers and oligomers, for instance, may be formulated into the above thermoplastic resin for modification purposes.

The thermoplastic elastomer mentioned just above is not particularly restricted but includes styrenic elastomers, olefin elastomers, urethane elastomers, and polyester elastomers, among others. These thermoplastic elastomers may be formulated each independently or in a combination of two or more species. The oligomer referred to above is not particularly restricted, either, but may for example be a maleic anhydride-modified polyethylene oligomer. Such oligomers may be used each independently or in a combination of two or more species. Furthermore, the thermoplastic elastomer and oligomer may be used either one of them alone or both together.

Where necessary but within the range not interfering with accomplishment of the object of the invention, the above thermoplastic resin may contain one or more additives, such as a nucleating agent capable of providing nuclei for fine crystal growth as a supportive means for making physical characteristics uniform, an antioxidant (aging inhibitor), a heat stabilizer, a light stabilizer, an ultraviolet absorber, a lubricant, a fire retardant additive, an antistatic agent, and an anti-fog additive, among others.

The term “lamellar silicate” as used in this description referring to the sheet-form molding according to the first aspect of the invention means a silicate mineral containing exchangeable metal cations between its layers.

The lamellar silicate is not particularly restricted but includes smectite clay minerals such as montmorillonite, saponite, hectorite, beidellite, stevensite, nontronite, etc., vermiculite, halloysite, and swollen mica, among others. Among these, montmorillonite and/or swollen mica is used with advantage. The above lamellar silicates may be naturally-occurring silicates or synthetic silicates. Moreover, these lamellar silicats may be used each independently or in a combination of two or more species.

As the lamellar silicate mentioned above, smectites and swollen mica, which are large in the shape-anisotropic effect defined below, are preferred. By using a lamellar silicate having a large shape-anisotropic effect, the mechanical strength of the thermoplastic resin composition can be further improved.
Shape anisotropic effect=area of crystal surface (A)/area of crystal surface (B)
where crystal surface (A) means the surface of the layer and crystal surface (B) means the lateral surface of the layer.

The morphological parameters of said lamellar silicate are not particularly restricted but a silicate having a length of 0.01 to 3 μm, a thickness of 0.001 to 1 μm, and an aspect ratio of 20 to 500, on the average, is preferred and one having a length of 0.05 to 2 μm, a thickness of 0.01 to 0.5 μm, and an aspect ratio of 50 to 200, on the average, is still more preferred.

The exchangeable metal cations located between layers of said lamellar silicate are metal ions, such as sodium and calcium ions, which are present on the crystal surface of the lamellar silicate, and because these metal ions are capable of undergoing ion-exchange with various other cations, various cationic substances can be intercalated between such crystal layers of a lamellar silicate.

The cation exchange capacity of said lamellar silicate is not particularly restricted but is preferably 50 to 200 mm equivalent/100 g. If it is less than 50 mm equivalent/100 g, the amount of a cationic substance which can be intercalated between crystal layers of the lamellar silicate by cation interchange is so small that a sufficient depolarization may not take place between crystal layers. If it exceeds 200 mm equivalent/100 g, the binding force between crystal layers of the lamellar silicate tends to be so strong that crystal flakes may not be readily exfoliated.

In case a low-polarity resin such as a polyolefin resin is used as the thermoplastic resin in the present invention, it is preferable to treat the interlayer milieu of the lamellar silicate with a cationic surfactant to make it hydrophobic in advance. By making the interlayer milieu of the lamellar silicate hydrophobic in advance, the affinity of the lamellar silicate for the thermoplastic resin can be increased to allow the lamellar silicate to be uniformly and microscopically dispersed in the resin.

The cationic surfactant mentioned above is not particularly restricted but includes quaternary ammonium salts and quaternary phosphonium salts, among others. Particularly a quaternary ammonium salt having an alkyl chain containing at least 6 carbon atoms, that is to say an alkylammonium salt of 6 or more carbon atoms, is used with advantage because it will successfully depolarize the crystal interlayer milieu of the lamellar silicate.

The quaternary ammonium salt mentioned above is not particularly restricted but includes lauryltrimethylammonium salts, stearyltrimethylammonium salts, trioctylammonium salts, distearyldimethylammonium salts, di(hydrogenated beef tallow)dimethylammonium salts, distearyldibenzylammonium salts, and N-polyoxyethylene-N-lauryl-N,N-dimethylammonium salts, among others. These quaternary ammonium salts can be used each independently or in a combination of two or more different salts.

The quaternary phosphonium salt mentioned above is not particularly restricted but includes dodecyltriphenylphosphonium salts, methyltriphenylphosphonium salts, lauryltrimethylphosphonium salts, stearyltrimethylphosphonium salts, trioctylphosphonium salts, distearyldimethylphosphonium salts, and distearyldibenzylphosphonium salts, among others. These quaternary phosphonium salts can be used each independently or in a combination of two or more species.

The lamellar silicate for use in the present invention can be chemically treated, as mentioned above, to improve its despersibility in the thermoplastic resin.

The method for such chemical treatment is not limited to the above-mentioned cation exchange method using a cationic surfactant (hereinafter referred to as chemical modification method (1) as well) but includes the following and other various methods. The lamellar silicate with its dispersibility in thermoplastic resin improved by said chemical modification method (1) or any of the following various chemical modification methods is hereinafter referred to sometimes as “organically-pretreated lamellar silicate”.

(2) A method such that the hydroxyl function on the crystal surface of the organically-pretreated lamellar silicate resulting from the chemical treatment according to said chemical modification method (1) is chemically treated with a compound having at least one functional group capable of binding a hydroxyl group chemically or at least one functional group having a high chemical affinity for a hydroxyl group, if not capable of binding it chemically, at the molecular terminus (hereinafter referred to sometimes as chemical modification method (2))

(3) A method such that the hydroxyl function on the crystal surface of the organically-pretreated lamellar silicate resulting from the chemical treatment according to said chemical modification method (1) is chemically treated using a compound having at least one functional group capable of binding a hydroxyl group chemically or at least one functional group having a high chemical affinity for a hydroxyl group, if not capable of binding it chemically, and a reactive functional group at the molecular termini (hereinafter referred to sometimes as chemical modification method (3)).

(4) A method such that the crystal surface of the organically-pretreated lamellar silicate resulting from the chemical treatment according to chemical modification method (1) is chemically treated with a compound having anionic surface activity (hereinafter referred to sometimes as chemical modification method (4)).

(5) A method such that, in chemical modification method (4), the chemical treatment is carried out using an anionic surface-active compound containing at least one reactive functional group in addition to the anion site within the molecular chain (hereinafter referred to sometimes as chemical modification method (5)).

(6) A method such that the organically-pretreated lamellar silicate resulting from the chemical treatment according to either chemical modification method (1) or chemical modification method (5) is admixed with a polymer having a functional group capable of reacting with a lamellar silicate, such as a maleic anhydride-modified polyolefin resin and the resulting composition is used (hereinafter referred to sometimes as chemical modification method (6)). These chemical modification methods may be used each independently or in a combination of two or more different methods.

Referring to the above chemical modification method (2), said functional group capable of binding the hydroxyl function chemically or said functional group having a high chemical affinity for it, if not capable of binding it chemically, is not particularly restricted but includes, inter alia, alkoxy group, epoxy group, carboxyl group inclusive of dibasic acid anhydride, hydroxyl group, isocyanato group, aldehyde group, etc. and other functional groups having high affinities for hydroxyl group.

The compound having a functional group capable of binding said hydroxyl function chemically or a functional group having a high chemical affinity for it, if not capable of binding it chemically, is not particularly restricted but includes those silane compounds, titanate compounds, glycidyl compounds, carboxylic acids, and alcohols having any of the functional groups mentioned by way of example, among others. These compounds can be used each independently or in a combination of two or more species.

The silane compound referred to above is not particularly restricted but includes vinyltrimethoxysilane, vinyltriethoxysilane, vinyltris(β-methoxyethoxy)silane, γ-aminopropyltrimethoxysilane, γ-aminopropylmethyldimethoxysilane, γ-aminopropyldimethylmethoxysilane, γ-aminopropyltriethoxysilane, γ-aminopropylmethyldiethoxysilane, γ-aminopropyldimethylethoxysilane, methyltriethoxysilane, dimethyldimethoxysilane, trimethylmethoxysilane, hexyltrimethoxysilane, hexyltriethoxysilane, N-β-(aminoethyl)γ-aminopropyltrimethoxysilane, N-β-(aminoethyl)γ-aminopropyltriethoxysilane, N-β-(aminoethyl)γ-aminopropylmethyldimethoxysilane, octadecyltrimethoxysilane, octadecyltriethoxysilane, γ-methacryloyloxypropylmethyldimethoxysilane, γ-methacryloyloxypropylmethyldiethoxysilane, γ-methacryloyloxypropyltrimethoxysilane, and γ-methacryloyloxypropyltriethoxysilane, among others. These silane compounds can be used each independently or in a combination of two or more species.

Referring to said chemical modification method (4) and chemical modification method (5), the compound having anionic surface activity and/or a compound having anionic surface activity and containing at least one reactive functional group in addition to the anion site within the molecular chain may be any compound that is capable of modifying a lamellar silicate chemically by ionic interaction, thus including sodium laurate, sodium stearate, sodium oleate, higher alcohol sulfate ester salts, secondary higher alcohol sulfate ester salts, and unsaturated alcohol sulfate ester salts, among others. These compounds can be used each independently or in a combination of two or more species.

As a version of said chemical modification method (6), there can be mentioned the method in which a composition prepared by adding a polymer having a functional group capable of reacting with a lamellar silicate, such as a maleic anhydride-modified polyolefin resin, is used as a dispersant. The principle of this method is that such a dispersant containing a site having a high affinity for a lamellar silicate and a site having a high affinity for the thermoplastic resin, which is the base resin, is formulated to increase the compatibility of the two and, hence, reduce the energy required for dispersing the lamellar silicate.

As the dispersant mentioned above, a maleic anhydride-modified polyolefin oligomer can be used with advantage. In particular, the A-B diblock polymer or diblock oligomer having dissimilar properties at the two termini of the molecule is used with advantage. The dispersant having dissimilar properties at the two termini of the molecule (high affinities for lamellar silicate and thermoplastic resin, respectively) and a structure of the A (the site of affinity for lamellar silicate)-B (the site of affinity for thermoplastic resin) type achieves a satisfactory dispersion effect because it expresses the respective affinities with good efficiency.

The technology of realizing a high dispersion state with the above A-B type dispersant includes a method, which comprises melt-kneading the thermoplastic resin, lamellar silicate, and said dispersant together in an extruder, although this is not an exclusive choice.

The lamellar silicate for use in the first aspect of the present invention is preferably such that the mean interlayer distance in the (001) plane as measured by wide-angle X-ray diffractometry is not less than 3 nm and that it has been partially or totally dispersed as a dispersoid comprising not more than 5 layers. More preferably, the mean interlayer distance referred to above is not less than 6 nm and the silicate has been partially or totally dispersed as a dispersoid comprising not more than 5 layers. It should be understood that, as used in this description, the term “mean interlayer distance of a lamellar silicate” means the average distance between layers assuming that a microscopic flaky crystal of the lamellar silicate is a layer and can be calculated from the X-ray diffraction peak and transmission electron microscope photographing, that is wide-angle X-ray diffractometry. Moreover, the dispersion state of the lamellar silicate can be determined by observing a sample with a transmission electron microscope at 50,000 to 100,000 magnification, counting the dispersoid (Y) comprising not more than 5 layers among the dispersoid observed per unit area (X), and making a calculation by means of the following equation.
Percentage of lamellar silicate dispersed as a dispersoid comprising not more than 5 layers (%)=(Y/X)×100

As the lamella-forming molecules of a lamellar silicate which is inherently a stack of scores of layers are exfoliated and dispersed, the interaction between crystal flaky layers of the lamellar silicate is weakened to an almost negligible level so that the crystal flakes are microscopically dispersed and stabilized at preserving a fixed space in the thermoplastic resin. As a result, the mean interlayer distance of crystal flakes is increased and the lamellar silicate is stabilized in dispersed state, with the result that the composition is facilitated to form a sintered artifact on combustion due to migration of crystal flakes. Thus, the thermoplastic resin composition having such crystal flaky layers dispersed at a mean interlayer distance of at least 3 nm, more preferably at least 6 nm, is likely to form a sintered artifact which may serve as a fire-retardant film. Since this sintered artifact is formed in an early phase of combustion, it not only blocks the supply of oxygen from the outside but also wards off the combustible gas and accordingly depresses the exotherm rate of the thermoplastic resin composition. Stated differently, this enables expression of effective flame spread-controlling properties. Therefore, the sheet-form molding according to the first aspect of the invention as prepared by formulating and dispersing such a lamellar silicate in a thermoplastic resin is capable of expressing remarkably superior fire retardancy, mechanical strength, heat resistance, and other performance characteristics. Moreover, when the mean interlayer distance of the lamellar silicate is not less than 3 nm, preferably 6 nm or greater, the crystal flaky layers of the lamellar silicate are so removed from each other that the interaction of crystal flaky layers is almost negligible, with the consequent advantage that the dispersed state of crystal flakes constituting the lamellar silicate in the thermoplastic resin progresses toward stabilization by disintegration.

That the lamellar silicate is partially or totally dispersed as a dispersoid comprising not more than 5 layers means that at least some or all of lamellar molecules of the lamellar silicate which is inherently a stack of scores of layers have been exfoliated and broadly dispersed, and this condition is also equivalent to a weakened interaction between crystal flaky layers of the lamellar silicate and, hence, is conducive to the same effect as above. Regarding the above requirement that a portion or the whole of the lamellar silicate has been dispersed as a dispersoid comprising not more than 5 layers, it is preferable that specifically at least 10% of the lamellar silicate has been dispersed as a dispersoid comprising not more than 5 layers and it is more preferable that at least 20% of the lamellar silicate has been dispersed as a dispersoid comprising not more than 5 layers.

Regarding the number of layers of the lamellar silicate, while the above effect can be obtained when the lamellar silicate has been exfoliated into 5 layers at most, it is more preferable that the lamellar silicate has been exfoliated into a maximum of 3 layers, and it is still further preferable that the silicate has been disintegrated into monolayer flakes.

When, as in the thermoplastic resin composition of the invention, the mean interlayer distance of the lamellar silicate is not less than 3 nm and a portion or the whole of the lamellar silicate has been dispersed into 5 layers at most, that is to say the lamellar silicate has been highly dispersed in the thermoplastic resin, the interfacial area between the thermoplastic resin and the lamellar silicate is increased. As the interfacial area between the thermoplastic resin and the lamellar silicate is increased, the degree of binding of the thermoplastic resin on the surface of the lamellar silicate is increased to improve the elastic modulus and other mechanical strength. Moreover, as the degree of binding of the thermoplastic resin on the surface of the lamellar silicate is increased, not only melt viscosity but also moldability is improved. Furthermore, the “baffle” effect of the lamellar silicate contributes to the expression of gas barrier properties. In addition, the existence of the lamellar silicate in 5 layers at most is advantageous in terms of the retention of strength of the lamellar silicate itself, being particularly contributory to expression of mechanical strength, especially elastic modulus.

The sheet-form molding according to the present invention has at least one layer containing 0.1 to 100 weight parts of said lamellar silicate (inclusive of said organically-pretreated lameliar silicate) in each 100 weight parts of a thermoplastic resin. If the proportion of said lamellar silicate is less than 0.1 weight part, an integral sintered artifact may hardly be formed on combustion so that the fire retardant effect will be small. Exceeding 100 weight parts is not practically reasonable, for mechanical strength and moldability would then be undermined to the practically unacceptable extent. The preferred proportion is 1 to 40 weight parts and, in order to provide for formation of an integral film and sufficient mechanical strength, the more preferred proportion is 4 to 30 weight parts. To obtain a particularly high film strength, the proportion of 7 to 20 weight parts is especially recommendable.

The technology of dispersing the lamellar silicate in the thermoplastic resin is not particularly restricted but includes the method using said organic-pretreated silicate; the method which comprises kneading the thermoplastic resin and lamellar silicate together in the conventional manner and, then, causing the mixture to undergo foaming; and the method utilizing a dispersing agent; among others. By using any of such techniques, the lamellar silicate can be dispersed more uniformly and microscopically in the thermoplastic resin.

The above method, which comprises kneading the thermoplastic resin and lamellar silicate together in the conventional manner and, then, causing the mixture to undergo foaming is first described. This method is characterized in that treating with a blowing agent, and forming the thermoplastic resin and, then, the resultant foaming energy is converted to a dispersing energy.

The blowing agent mentioned above is not particularly restricted but may for example be a gaseous blowing agent, an easily volatilizable liquid blowing agent, or a thermally discomposable solid blowing agent. These blowing agents can be used each independently or in a combination of two or more kinds.

The specific method of causing a thermoplastic resin to undergo foaming in the presence of a lamellar silicate to thereby disperse the lamellar silicate in the thermoplastic resin is not particularly restricted but includes, inter alia, the dispersing method which comprises using a composition comprising 100 weight parts of the thermoplastic resin and 0.1 to 100 weight parts of the lamellar silicate, either introducing a gaseous blowing agent into the composition under high pressure or kneading an easily volatilizable liquid blowing agent into the composition and causing either the gaseous blowing agent or easily volatilizable bowing agent to be gasified within the composition to produce a foam; and the dispersing method which comprises introducing a thermally decomposable solid blowing agent into the interlayer milieu of the lamellar silicate and causing the thermally decomposable solid blowing agent to be decomposed under heating to implement a foam structure, among others.

The more extensively the lamellar silicate is exfoliated and its crystal flakes dispersed in the thermoplastic resin, the smaller is the mean distance between adjacent flakes, with the result that, in combustion, the formation of a sintered artifact due to migration of crystal flakes of the lamellar silicate is facilitated. Moreover, the higher the degree of dispersion of lamellar silicate crystal flakes in the thermoplastic resin is, the greater are improvements in the elastic modulus and gas barrier properties of the thermoplastic resin composition of the invention.

All the above phenomena are attributable to the expansion of the interfacial area between the lamellar silicate and thermoplastic resin due to the increased dispersion of the crystal flakes. Thus, as the molecular movement of the thermoplastic resin is restricted on the bonding surface between the thermoplastic resin and the lamellar silicate, the elastic modulus and other mechanical strength properties of the thermoplastic resin are improved. Therefore, the higher the rate of dispersion of crystal flakes is, the greater is the effect of increasing the mechanical strength of the thermoplastic resin composition of the invention.

Furthermore, since gas molecules are generally by far ready to spread by diffusion in polymers as compared with inorganic matter, when the gas molecules diffusing through a thermoplastic resin, it diffuse bypassing or avoiding the inorganic matter. Therefore, in the instant case, too, the greater is the improvement in the rate of dispersion of lamellar silicate crystal flakes, the more efficient is the improvement in the gas barrier performance of the thermoplastic resin composition of the invention.

The sheet-form molding according to the first aspect of the invention has at least one layer constructed by formulating 0.1 to 100 weight parts of a lamellar silicate and 0.1 to 70 weight parts of a metal hydroxide and/or 0.1 to 50 weight parts of a melamine derivative in each 100 weight parts of a thermoplastic resin. Among these constituent materials, the metal hydroxide and melamine derivative function as fire retardant additives.

The metal hydroxide mentioned above contributes to an increased fire retardation effect of the lamellar silicate. As the result of its use in combination with the lamellar silicate, the adverse effect accompanying a massive addition of a fire retardant additive, such as the metal hydroxide, which has been pointed at the outset in connection with the prior art, is avoided and a sufficient fire retardation effect is obtained by using it in a comparatively small amount.

The metal hydroxide mentioned above is not particularly restricted but magnesium hydroxide, aluminum hydroxide, calcium hydroxide, among others, can be employed with advantage. These metal hydroxides can be used each independently or in a combination of two or more species.

The form of said metal hydroxide is not particularly restricted, and it may have been kneaded into the base resin at a high concentration in advance (in a master batch form) or may have been surface-treated.

The melamine derivative mentioned above is not particularly restricted but includes melamine, melamine cyanurate, melamine isocyanurate, and the corresponding surface-treated materials.

The formulating amounts of said metal hydroxide and/or melamine derivative based on 100 weight parts of the thermoplastic resin in at least one layer of the sheet-form molding according to the first aspect of the invention are 0.1 to 70 weight parts and 0.1 to 50 weight parts, respectively. If the formulating amount of the metal hydroxide and/or melamine derivative is less than 0.1 weight part, a sufficient fire retardation effect will not be obtained. On the other hand, if the formulating amount of the metal hydroxide exceeds 70 weight parts or the formulating amount of the melamine derivative exceeds 50 weight parts, the flexibility and elongation of the thermoplastic resin composition are drastically decreased. The formulating level leading to the optimum expression of the objective effect is 1 to 65 weight parts of a metal hydroxide and/or 1 to 45 weight parts of a melamine derivative. A still more eminent expression of the synergistic effect of these additives and the lamellar silicate is 10 to 60 weight parts of the metal hydroxide and/or 5 to 40 weight parts of the melamine derivative.

In at least one layer of the sheet-form molding according to the first aspect of the invention, there may be incorporated, in addition to the essential constituent materials described hereinbefore, i.e. thermoplastic resin, lamellar silicate, and metal hydroxide and/or melamine derivative, one or more other additives, such as the filler, softening agent, plasticizer, lubricant, antistatic agent, antifog additive, pigment, antioxidant (aging inhibitor), heat stabilizer, light stabilizer, ultraviolet absorber, etc., within the range not interfering with accomplishment of the object of the invention.

The technology of producing the thermoplastic resin composition for use in at least one layer of the sheet-form molding according to the first aspect of the invention is not particularly restricted but includes, inter alia, the method (direct compounding method) in which predetermined amounts of the thermoplastic resin, lamellar silicate, metal hydroxide and/or melamine derivative and predetermined amounts of optional additives, one or more of which may be added where necessary, are directly formulated and kneaded together at atmospheric temperature or under heating, and the method (master batch method) in which a predetermined amount of the lamellar silicate is formulated and kneaded together with a portion of said predetermined amount of the thermoplastic resin to prepare a master batch in the first place and this master batch is further kneaded together with the remainder of the thermoplastic resin, said metal hydroxide and/or melamine derivative, and one or more said optional additives at atmospheric temperature or under heating.

The concentration of the lamellar silicate in said master batch is not particularly restricted but it is preferable to use 1 to 500 weight parts of the lamellar silicate based on each 100 weight parts of the thermoplastic resin. If it is less than 1 weight part, the convenience feature of a master batch, i.e. dilutability to a desired concentration, will be lost. If it exceeds 500 weight parts, the dispersibility of the master batch itself and, in particular, the dispersibility of the lamellar silicate at the stage of diluting the master batch with the thermoplastic resin to an objective final formulation tend to be adversely affected. The more preferred range is 5 to 300 weight parts of the lamellar silicate.

The specific production method for the preparation of the composition by the above direct compounding method or master batch method is not particularly restricted but includes, inter alia, the method such that, using a kneading machine such as an extruder, a twin roll, or a Banbury mixer, predetermiend amounts of the constituent thermoplastic resin, lamellar silicate, and metal hydroxide and/or melamine derivative and predetermiend amounts of various optional additives which may be added where necessary, are uniformly melt-kneaded at atmospheric temperature or under heating, and the method such that said thermoplastic resin, lamellar silicate, metal hydroxide and/or melamine derivative, and one or more of said optional additives which may be added where necessary, are uniformly kneaded in a solvent capable of dissolving or dispersing these substances. Any of these production methods can be employed.

An alternative method which can be used in case a polyolefin resin is used as the thermoplastic resin comprises co-kneading a lamellar silicate containing a polymerization catalyst (polymerization initiator), such as a transition metal complex, and the olefinic monomer to constitute the polyolefin resin and polymerizing said olefinic monomer, thus effecting the production of the polyolefin resin and the production of the thermoplastic resin composition concurrently in one operation.

The sheet-form molding according to the first aspect of the invention is preferably such that when, in a combustion test according to ASTM E 1354, it is combusted by heating under a radiant heating condition of 50 kW/m² for 30 minutes and the combustion residues are compressed at a rate of 0.1 cm/s, the yield stress is not less than 4.9 kPa. If the yield stress is less than 4.9 kPa, the combustion residues tend to be easily disintegrated by the slightest force so that the fire retardation and flame spread prevention effects will become insufficient. Thus, in order that the sheet-form molding according to the first aspect of the invention may sufficiently express the function of a fire retardant casing, it is preferable that the sintered artifact should retain its shape till completion of combustion. The more preferred yield stress is not less than 15.0 kPa.

The second aspect of the present invention is concerned with a sheet-form molding such that when it is laminated with a non-combustible material and combusted under a radiant heating condition of 50 kW/m² in accordance with ISO 1182, the time in which the maximum exotherm rate is continuously not less than 200 kW/m² during a 20-minute period immediately following the start of heating is less than 10 seconds and the total exotherm amount is not over 8 MJ/m², and that it has a thickness of not less than 20 μm.

If the time over which the maximum exotherm rate is persistently over 200 kW/m² during the 20-minute period immediately following the start of combustion is more than 10 seconds or said total exotherm amount exceeds 8 MJ/m², the flame retardation and flame spread prevention effect of the sheet-form molding will be insufficient. If the thickness of the sheet-form molding is less than 20 μm, the sheet-form molding will not depend on its combustibility; thus, the amount of combustible matter is so small that both the total exotherm amount and the maximum exotherm rate are small and low, but if the thickness of the sheet-form molding is excessively reduced, the fundamental dynamic characteristics of a sheet and, hence, the practical utility of the sheet, are lost.

The sheet-form molding according to the second aspect of the invention preferably meets the requirements of the gas toxicity test according to ISO 1182, that is to say the mean standstill time of mice is not less than 6.8 minutes. A standstill time of less than 6.8 minutes means evolution of toxicity gases on combustion and, therefore, the risk for inducing secondary hazards such as gas poisoning in the event of a fire.

Preferably the sheet-form molding according to the first or the second aspect of the invention has a density of 0.90 to 1.20 g/cm³. The sheet-form molding according to the first or the second aspect of the invention, which has at least one layer containing said thermoplastic resin, lamellar silicate, and metal hydroxide and/or melamine derivative in the defined amounts, usually has a density of not less than 0.9 g/cm³. If the density exceeds 1.20 g/cm³, the sheet-form molding approaches to that of polyvinyl chloride resin in specific gravity so that not only its separation from the decorative sheet of polyvinyl chloride resin becomes difficult in classified recovery but also the workability in transportation and application in the field is adversely affected.

The sheet-form molding according to the first or the second aspect of the invention, which has at least one adhesive/pressure-sensitive adhesive layer is also an embodiment of the invention. The adhesive/pressure-sensitive adhesive layer mentioned just above is preferably located on the reverse side of the sheet-form molding with respect to the application surface. When the sheet-form molding is provided with such an adhesive/pressure-sensitive adhesive layer, it is unnecessary to apply an adhesive/pressure-sensitive adhesive to the base or substrate in the application or installation of the sheet-form molding, thus contributing to the ease of application. The sheet-form molding according to the first or the second aspect of the invention, which has a pigmented layer and a transparent layer in addition to said adhesive/pressure-sensitive adhesive layer is also an embodiment of the invention. In this embodiment, it is preferable that the sheet-form molding according to the first aspect of the invention be utilized for the pigmented layer, although this is not an exclusive choice. When the sheet-form molding is utilized as a pigmented layer, a more effective expression of fire retardation and other functions can be expected. Furthermore, the multi-layer sheet-form molding provided with a layer containing 0.1 to 100 weight parts of a lamellar silicate in each 100 weight parts of the thermoplastic resin, in addition to an adhesive/pressure-sensitive adhesive layer, is also an embodiment of the invention. Since the layer comprising a lamellar silicate microscopically dispersed in a thermoplastic resin retains a certain degree of transparency, it is suited as a clear surface layer of the sheet-form molding. By using the sheet-form molding having a clear layer formed from the above composition, particularly in the case where the sheet-form molding according to the first invention is used for the pigmented layer as well, it is possible to have a casing formed in the surface layer on combustion so that the positive maintenance and improvement of fire retardancy can be expected.

The third aspect of the present invention is concerned with a decorative sheet comprises the sheet-form molding according to the first or the second aspect of the invention. The thickness of the decorative sheet according to the third aspect of the invention, exclusive of the adhesive/pressure-sensitive adhesive layer, can be judiciously established according to the type and intended use of the sheet and, therefore, is not particularly restricted. The preferred thickness, however, is not less than 100 μm but less than 400 μm. If it is less than 100 μm, the effect of hiding the base wall material pattern or the like will be insufficient so that the sheet will not be practically acceptable and, moreover, the necessary dynamic strength may hardly be secured. If said thickness exceeds 400 μm, the quantity of combustible matter per unit area is so large as to make combustility control difficult and the weight per unit area is increased to impose an increased burden on installation workers, which is a practical disadvantage. The more preferred thickness is not less than 120 μm but less than 250 μm.

The decorative sheet according to the third aspect of the invention is preferably a laminate comprising, reckoning from the face layer side, a transparent film layer, a printed film layer, a pigmented layer, and an adhesive/pressure-sensitive adhesive layer in the order mentioned. By using the sheet-form molding according to the first aspect of the invention for whichever one of the transparent film layer and the pigmented film layer, there can be implemented physical properties and characteristics tailored to the kind and end-use of the objective decorative sheet. Moreover, when a polypropylene alloy resin is used as said thermoplastic resin, a highly flexible sheet can be obtained so that a decorative sheet having both flexibility and combustion resistance characteristics can be provided. A highly flexible means that it is highly resistant to injury that might be incurred during application or transportation and this is a positive asset in that the sheet is easy to handle in application.

The fourth aspect of the present invention is concerned with an ornamental pressure-sensitive adhesive sheet comprises the sheet-form molding according to the first or the second aspect of the invention. The thickness of the ornamental sheet according to the fourth aspect of the invention, exclusive of the adhesive/pressure-sensitive adhesive layer, can be judiciously established according to the kind and end-use, for instance, of the objective ornamental pressure-sensitive adhesive sheet and is not particularly restricted but the preferred thickness is not less than 20 μm but less than 160 μm. If it is less than 20 μm, the ornamental pressure-sensitive adhesive sheet itself will be too flexile for field application and may be deficient in strength. If it exceeds 160 μm, the ornamental pressure-sensitive adhesive sheet will be so rigid that it tends to be poor in compliance to an adherend or substrate having a cubic-curved surface, for instance. The more preferred thickness is 40 to 60 μm. The ornamental pressure-sensitive adhesive sheet according to the fourth aspect of the invention is preferably a laminate comprising, reckoning from the face layer side, a transparent or pigmented transparent, a pigmented film, and an adhesive/pressure-sensitive adhesive layer in the order mentioned. By using the sheet-form molding according to the first aspect of the invention for whichever one of said transparent film or pigmented transparent film layer and said pigmented film layer, physical properties and characteristics tailored to the kind and end-use, for instance, of the sheet can be implemented.

The decorative sheet according to the third aspect of the invention and the ornamental pressure-sensitive adhesive sheet according to the fourth aspect of the invention preferably has an elongation after fracture of which is not less than 80%. If it is less than 80%, the compliance to a cubic-cured surface will be too low for practical utility. The more preferred elongation after fracture is 100% or more.

The decorative sheet according to the third aspect of the invention and the ornamental pressure-sensitive adhesive sheet according to the fourth aspect of the invention preferably has a modulus at 2% elongation of 2 to 40 N/10 mm. If it is less than 2 N/10 mm, the sheet will be so soft that a linear application work in the field will be rendered difficult and, moreover, when in the butt-installation of a plurality of sheets, gaps tend to be created as a practical drawback. If the limit of 40 N/10 mm is exceeded, the compliance to a surface having a cubic curvature is decreased to interfere with installation. The more preferred modulus is 5 to 30 N/10 mm.

In the case where the decorative sheet according to the third aspect of the invention or the ornamental pressure-sensitive adhesive sheet according to the fourth aspect of the invention has an adhesive/pressure-sensitive adhesive layer, the adhesive/pressure-sensitive adhesive for use in the formation of said adhesive/pressure-sensitive adhesive layer is not particularly restricted but includes those various adhesives/pressure-sensitive adhesives which are in routine use for adhesive/pressure-sensitive adhesive sheets or adhesive/pressure-sensitive adhesive tapes, such as elastomer (rubber) adhesives/pressure-sensitive adhesives, acrylic resin series adhesives/pressure-sensitive adhesives, polyvinyl ether resin adhesives/pressure-sensitive adhesive, silicone resin adhesives/pressure-sensitive adhesives, and so forth.

The form of said adhesive/pressure-sensitive adhesive is not particularly restricted but may for example be any of the solvent type adhesive/pressure-sensitive adhesive, non-aqueous emulsion type adhesive/pressure-sensitive adhesive, emulsion type adhesive/pressure-sensitive adhesive dispersion type adhesive/pressure-sensitive adhesive, hot melt type adhesive/pressure-sensitive adhesive, and monomer- or oligomer-type adhesive/pressure-sensitive adhesive which may be cured (polymerized) with an actinic radiation such as ultraviolet light. Moreover, said adhesive/pressure-sensitive adhesive may be a crosslinking adhesive/pressure-sensitive adhesive or a non-crosslinking adhesive/pressure-sensitive adhesive, and a one-package adhesive/pressure-sensitive adhesive or a pluri-package adhesive/pressure-sensitive adhesive.

The above adhesive/pressure-sensitive adhesive is preferably a fire-retardant adhesive/pressure-sensitive adhesive. By forming an adhesive/pressure-sensitive adhesive layer comprising a fire-retardant adhesive/pressure-sensitive adhesive on the reverse side (non-decorative side/adherend side) of the decorative sheet according to the third aspect of the invention and the ornamental pressure-sensitive adhesive sheet according to the fourth aspect of the invention, the fire retadancy of the decorative sheet or the ornamental pressure-sensitive adhesive sheet, as the case may be, can be further improved.

The technology of manufacturing the decorative sheet according to the third aspect of the invention and the ornamental pressure-sensitive adhesive sheet according to the fourth aspect of the invention is not particularly restricted but includes the method in which a composition prepared in advance is melt-kneaded and extruded, by means of an extruder, into a sheet via a T-die or a circular die, the method in which said composition is dissolved or dispersed in a solvent, for example an organic solvent and the resulting solution or dispersion is cast into a sheet, and the calendermolding method in which said composition is melt-kneaded and calenderedmolding with a roll. Among these methods, the calendermolding method is preferred. The calendermolding method which comprises melt-kneading and stretching the molten resin on a calender roll is considered to be a pertinent technique in terms of reductions in loss of materials associated with resin switches in many item, small-lot production and in terms of adaptability to a full assortment of products. However, because olefin resins have low melt viscosities at high temperatures, among others reasons, the calender-moldable temperature range is narrow and, hence, these resins are generally considered to be unsuited to the calendermolding method. In the present invention, too, various molding auxiliary agents may be added within the range not interfering with expression of the effect of the invention. Particularly, addition of auxiliary agents for calendermolding may be reasonably contemplated, and it is good practice to have the surface of a fire retardant additive coated with a calendering auxiliary agent for the decorative sheet according to the third aspect of the invention and the ornamental pressure-sensitive adhesive sheet according to the fourth aspect of the invention.

The technique of adding said calendering auxiliary agent is not particularly restricted but the dispersion of the calendering auxiliary agent in the resin with good uniformity can be facilitated by adopting the method in which the surface of the fire retardant additive is coated with the calendering auxiliary agent. Moreover, by using a specialized calendering auxiliary agent (lubricant), the compatibility between the resin and the fire retardant additive can be improved at the same time.

As the calendering auxiliary agent for improving the compatibility between the resin and the fire retardant additive, a fatty acid metal soap can be used with advantage. The fatty acid metal soap is not particularly restricted but includes calcium stearate, magnesium stearate, zinc stearate, aluminum stearate, sodium stearate, lithium stearate, potassium stearate, calcium behenate, magnesium behenate, zinc behenate, aluminum behenate, sodium behenate, lithium behenate, potassium aluminum behenate, sodium behenate, lithium behenate, potassium behenate, calcium 12-hydroxystearate, magnesium 12-hydroxystearate, zinc 12-hydroxystearate, aluminum 12-hydroxystearate, sodium 12-hydroxystearate, lithium 12-hydroxystearate, potassium aluminum 12-hydroxystearate, sodium 12-hydroxystearate, lithium 12-hydroxystearate, potassium 12-hydroxystearate, calcium montanate, magnesium montanate, zinc montanate, aluminum montanate, sodium montanate, lithium montanate, potassium aluminum montanate, sodium montanate, lithium montanate, and potassium montanate, among others. The preferred is calcium 12-hydroxystearate. These metal soaps can be used each independently or in a combination of two or more species.

The technology of constructing an adhesive/pressure-sensitive adhesive layer on the decorative sheet according to the third aspect of the invention and the ornamental pressure-sensitive adhesive sheet according to the fourth aspect of the invention is not particularly restricted but includes, inter alia, the method which comprises applying an adhesive/pressure-sensitive adhesive directly on the reverse side (non-decorative side) of the sheet-form molding according to the first aspect of the invention, followed by drying, cooling, and irradiation with an actinic energy beam, where necessary, to form an adhesive/pressure-sensitive adhesive layer and optionally laminating a releaser, such as release paper (peeling paper) or release film, with its parting surface in contact with the pressure-sensitive adhesive layer (direct coating method), and the method which comprises forming an adhesive/pressure-sensitive adhesive layer on the parting surface of a releaser in the same manner as above and laminating this adhesive/pressure-sensitive adhesive layer on one side of the sheet of the invention to thereby transfer the adhesive/pressure-sensitive adhesive layer to one side of the sheet (transfer method). Any of these methods can be employed. To provide for improved adhesion to the adhesive/pressure-sensitive adhesive layer, said one side of the sheet may have been subjected to surface preparation (pretreatment) such as corona discharge treatment or application of a primer (an undercoat).

The thickness of said adhesive/pressure-sensitive adhesive layer is not particularly restricted but, in terms of the solids thickness, is preferably 10 to 60 μm. If it is less than 10 μm, no sufficient pressure-sensitive adhesive force may be obtained. If it exceeds 60 μm, the product might not be of use as a decorative sheet or an ornamental pressure-sensitive adhesive sheet.

The fifth aspect of the present invention is concerned with a tape comprising the sheet-form molding according to the first or the second aspect of the invention.

The sixth aspect of the present invention is concerned with a tape comprising a tape base having a layer or layers containing 0.1 to 100 weight parts of a lamellar silicate in each 100 weight parts of a thermoplastic resin and the lamellar silicate is such that the mean interlayer distance in the (001) plane as measured by wide-angle X-ray diffractometry is not less than 3 nm and that it has been partially or totally dispersed as a dispersoid comprising not more than 5 layers. Where fire retardancy is required, magnesium hydroxide or a melamine derivative may be further formulated and the level of formulation can be judiciously established according to the intended use.

The thickness of the tape base layer according to the fifth or the sixth aspect of the invention is preferably 30 to 100 μm. If it is less than 30 μm, the product tape tends to be deficient in elastic modulus and mechanical strength. If the thickness exceeds 100 μm, a roll of the base layer ribbon will be so large in outer diameter that a large pay-out space will have to be provided and it is likely that the cost will also be increased.

The thermoplastic resin for the tape according to the sixth aspect of the invention may be the same as the resin used for the sheet-form molding according to the first aspect of the invention. Thus, polyolefin resins, polystyrene resins, polyester resins, polyamide resins, polyvinyl acetal resins, polyvinyl alcohol resins, polyvinyl acetate resins, poly(meth)acrylic ester resins, norbornene resins, polyphenylene ether resins, and polyoxymethylene resins, among others, can be used without any particular restriction. Among these resins, polyolefin resins are used with advantage. These thermoplastic resins can be used each independently or in a combination of two or more species. Moreover, just as in the first aspect of the invention, the thermoplastic resin is preferably a polyolefin resin from cost considerations and in view of its being lightweight, although this is not an exclusive choice. The polyolefin resin mentioned just above is as previously described in connection with the first aspect of the invention.

The lamellar silicate mentioned just above may also be the same silicate mineral containing exchangeable metal cations between lamellae as the one described in connection with the first aspect of the invention, and its aspect ratio and ion exchange capacity, as well as the surfactant that can be used, the method of production, and even the state of dispersion are also similar to those described for the lamellar silicate used in the first aspect of the invention. Thus, a highly dispersed state contributes to improvements in elastic modulus and other mechanical strength characteristics.

The tape according to the fifth or the sixth aspect of the invention is preferably such that, as determined according to JIS K 7113, the tensile stress at 5% strain is not less than 39.2 N/mm² or the tensile modulus of elasticty is not less than 784.0 N/mm². If the tensile stress is less than 39.2 N/mm² and the tensile modulus of elasticty is less than 784.0 N/mm², the dimensional accuracy tends to be poor so that the application accuracy will be sacrificed.

The seventh aspect of the present invention is concerned with a protect tape comprising the tape according to the fifth or the sixth aspect of the invention.

The eighth aspect of the present invention is concerned with a masking tape for plating which comprises the tape according to the fifth or the sixth aspect of the invention.

The technology of molding the base layer of the masking tape for plating according to the eighth aspect of the invention is not particularly restricted but there may be used any of the method in which a composition prepared in advance is melt-kneaded and extruded with an extruder equipped with a T-die or a circular die to form a film (sheet), the method in which such a composition as above is dissolved or dispersed in a solvent, for example an organic solvent, and the resulting solution or dispersion is cast into a film (sheet), and the method in which said composition and a pressure-sensitive adhesive agent for forming the pressure-sensitive adhesive layer to be described hereinafter are co-extruded to form a base layer and said pressure-sensitive adhesive layer in one operation. From productivity points of view, the bilayer coextrusion method is preferred.

The masking tape for plating according to the eighth aspect of the invention preferably comprises a base layer and, as disposed on one side thereof, an adhesive/pressure-sensitive adhesive layer.

The adhesive/pressure-sensitive adhesive to be used for the formation of said adhesive/pressure-sensitive adhesive layer is not particularly restricted but includes rubber type (elastomer series) pressure-sensitive adhesives, e.g. natural rubber series or synthetic rubber series pressure-sensitive adhesives, acrylic resin series pressure-sensitive adhesives, polyvinyl ether resin series pressure-sensitive adhesives, silicone resin series pressure-sensitive adhesives, and other synthetic resin type pressure-sensitive adhesives, which are in routine use for masking tapes. These adhesive/pressure-sensitive adhesive agents can be used each independently or in a combination of two or more species.

The form of said adhesive/pressure-sensitive adhesive agent is not particularly restricted but includes solvent-based adhesive/pressure-sensitive adhesives, nonaqueous emulsion type adhesive/pressure-sensitive adhesives, emulsion type adhesive/pressure-sensitive adhesives, dispersion type adhesive/pressure-sensitive adhesives, hot melt type adhesive/pressure-sensitive adhesives, and monomer type or oligomer type adhesive/pressure-sensitive adhesives which are curable (polymerizable) with an actinic energy beam such as ultraviolet light. Moreover, said adhesive/pressure-sensitive adhesive agent may be whichever of a non-crosslinking type adhesive/pressure-sensitive adhesive and a crosslinking type adhesive/pressure-sensitive adhesive or whichever of a one-package type adhesive/pressure-sensitive adhesive and a two- or multi-package adhesive/pressure-sensitive adhesive.

The thickness of the adhesive/pressure-sensitive adhesive layer resulting from application of said adhesive/pressure-sensitive adhesive agent is not particularly restricted but is preferably 1 to 20 μm on a solids basis. If it is less than 1 μm, the resulting masking tape for plating tends to be insufficient in adhesion (tackiness) and pressure-sensitive adhesive force. If the thickness exceeds 20 μm, the repeelability of the masking tape after plating tends to be sacrificed.

The technology of manufacturing a masking tape according to the eighth aspect of the invention is not particularly restricted but may for example be any of the method which comprises applying the pressure-sensitive adhesive directly to a predetermined (one) surface of said base layer using an ordinary coating device such as a roll coater, optionally followed by drying, cooling, and irradiation with an actinic energy beam or the like treatment, to form a pressure-sensitive adhesive layer and, then, optionally laminating the release-treated surface of a releaser such as release paper (peeling paper) or release film on the pressure-sensitive adhesive layer (direct coating method), the method which comprises forming a pressure-sensitive adhesive layer on the release-treated surface of a releaser in the same manner as above and laminating this pressure-sensitive adhesive layer on the predetermined surface of the base layer to transfer the pressure-sensitive adhesive layer to the predetermined surface of the base layer (transfer method) and the method which comprises coextruding a polypropylene resin composition for the base layer and a pressure-sensitive adhesive for the pressure-sensitive adhesive layer to concurrently achieve formation of the base layer and formation of the pressure-sensitive adhesive layer in one operation (bilayer extrusion method). However, from productivity points of view, the bilayer coextrusion method is preferred. For achieving a still enhanced adhesion of the pressure-sensitive adhesive layer, the predetermined surface of the base layer may be subjected to surface preparation (pretreatment) such as corona discharge treatment, plasma discharge treatment, application of a primer (an undercoat), or the like.

Because the sheet-form molding according to the first aspect of the invention comprises at least one layer formed by molding a composition containing a lamellar silicate in a defined ratio to a thermoplastic resin, a sintered artifact of the lamellar silicate is formed on combustion so that the form of the combustion residues is retained. Therefore, the form will not collapse even after combustion so that the spread of the fire can be effectively prevented. Thus, the sheet-form molding according to the first aspect of the invention expresses excellent fire retardant and excellent flame spread-preventive effects. Moreover, since the lamellar silicate may impart good fire retardancy even if not formulated in a large quantity required of the ordinary fire retardant additive, the sheet-form molding according to the first aspect of the invention retains excellent mechanical strength properties. In addition, because no massive addition of a fire retardant additive is required, the load in installation can be alleviated.

The decorative sheet according to the third aspect of the invention and the ornamental pressure-sensitive adhesive sheet according to the fourth aspect of the invention are not only enhanced in elastic modulus and gas barrier properties but also improved in heat resistance due to elevation of the thermal deformation-withstanding temperature by the binding of the molecular chain and improved dimensional stability due to the nucleating effect of crystals of the lamellar silicate.

The tape according to the fifth or the sixth aspect of the invention and the protect tape according to the seventh aspect of the invention, and the masking tape for plating according to the eighth aspect of the invention, both of which comprise said tape according to the fifth or the sixth aspect of the invention, each comprises a base layer having a high dimensional accuracy as molded from a composition containing a lamellar silicate in a defined ratio to, and microscopically dispersed in, a thermoplastic resin, particularly a polypropylene resin and, as such, expresses an excellent installation or application accuracy. The masking tape for plating according to the eighth aspect of the invention is used with advantage for the masking of non-plating areas in the plating of, inter alia, lead frame metal sheets on electronic components.

### BEST MODE FOR CARRYING OUT THE INVENTION

The following examples illustrate the present invention in further detail without defining the scope of the invention.

### EXAMPLE 1

A small extruder (TEX30, manufactured by The Japan Steel Works) was fed with ethylene-ethyl acrylate copolymer (DPDJ6182, product of Nippon Unicar), maleic anhydride-modified polyethylene oligomer (ER403A, product of Japan Polyolefins Co.), montmorillonite subjected to organic pretreatment with a distearyldimethyl(quaternary)ammonium salt (New Esben D, product of Hojun Kogyo), and magnesium hydroxide (Kisuma 5B, product of Kyowa Chemical Industry Co.) as blended in advance according to the formula presented in Table 1 and the mixture was melt-kneaded at a temperature setting of 170° C. and extruded into a strand. The strand was pelletized with a pelletizer to prepare pellets of a thermoplastic resin composition.

This pelletized thermoplastic resin composition was rolled on a hot press at 180° C. to fabricate a 3 mm-thick molded board and a 100 μm-thick sheet-form molding.

Then, one side of the 100 μm-thick sheet-form molding was treated with a corona discharge to a surface-wetting index of 42 dyn/cm. On the other hand, the silicone resin releaser-treated surface of a release paper was coated with a two-package acrylic resin pressure-sensitive adhesive using a comma-coater in a dry thickness of 40 μm, followed by drying to form a pressure-sensitive adhesive layer. This pressure-sensitive adhesive layer was laminated onto the corona discharge-treated surface of the above sheet-form molding to fabricate an end-product sheet-form molding having a pressure-sensitive adhesive layer.

### EXAMPLE 2

Using an ethylene-α-olefin copolymer (Karnel KF260, product of Nippon Polychem Co.) in lieu of the ethylene-ethyl acrylate copolymer (DPDJ6182, product of Nippon Unicar Co.), the procedure of Example 1 was otherwise repeated to prepare a pelletized thermoplastic resin composition, a 3 mm-thick board-form molding, and a 100 μm-thick sheet-form molding having a pressure-sensitive adhesive layer.

### EXAMPLE 3

Using a polypropylene alloy resin (Adflex KF084S, product of Sun-Allomer Co.), which is predominantly composed of a polypropylene resin and in which, of the total elution amount in cross-fractional chromatography, the elution amount at temperatures not over 10° C. is 48 weight % and the elution amount at temperatures over 10° C. up to 70° C. is 9 weight %, in lieu of the ethylene-ethyl acrylate copolymer (DPDJ6182, product of Nippon Unicar), the procedure of Example 1 was otherwise repeated to prepare a pelletized thermoplastic resin composition, a 3 mm-thick board-form molding, and a 100 μm-thick sheet-form molding having a pressure-sensitive adhesive layer.

### EXAMPLE 4

Using a random type polypropylene resin (Sun-Allomer PC630A, product of Sun-Allomer Co.) in lieu of 87.3 weight parts of the polypropylene alloy resin (Adflex KF084S, product of Sun-Allomer Co.) and a two-end diblock type oligomer (CB-OM12, product of Kuraray Co.) in lieu of the maleic anhydride-modified polyethylene oligomer (ER403A, product of Japan Polyolefins Co.), the procedure of Example 3 was otherwise repeated to prepare a pelletized thermoplastic resin composition, a 3 mm-thick board-form molding, and a 100 μm-thick sheet-form molding having a pressure-sensitive adhesive layer.

### EXAMPLE 5

Using a blend of a polypropylene alloy resin (Adflex KF084S, product of Sun-Allomer Co.) and a random type polypropylene resin (Sun-Allomer PC630A, product of Sun-Allomer Co.) in lieu of the polypropylene series alloy polymer (Adflex KF084S, product of Sun-Allomer Co.), the procedure of Example 3 was otherwise repeated to prepare a pelletized thermoplastic resin composition, a 3 mm-thick board-form molding, and a 100 μm-thick sheet-form molding having a pressure-sensitive adhesive layer.

### EXAMPLE 6 TO 10

Using a swellable fluoromica subujected to organic pretreatment with a distearyldimethyl(quaternary)ammonium salt (Somasif MAE-100, product of CO-OP Chemical Co.) in lieu of the montmorillonite subjected to organic pretreatment with a distearyldimethyl(quaternary)ammonium salt (New Esben D, product of Hojun Kogyo Co.), pelletized thermoplastic resin compositions, 3 mm-thick board-form moldings, and 100 μm-thick sheet-form moldings each having a pressure-sensitive adhesive layer were prepared in the same manner as in Examples 1 to 5.

### EXAMPLES 11 TO 15

Using magnesium hydroxide (Magseeds N-4, product of Konoshima Chemical Co.) surface-treated with calcium 12-hydroxystearate (CS-6, product of Nitto Kasei Co.) in lieu of the magnesium hydroxide (Kisuma 5B, product of Kyowa Chemical Industry Co.), pelletized thermoplastic resin compositions, 3 mm-thick board-form moldings, and 100 μm-thick sheet-form moldings each having a pressure-sensitive adhesive layer were prepared in the same manner as in Examples 6 to 10.

### EXAMPLES 16 TO 20

Using 10 to 35 weight parts of melamine cyanurate (product of Nissan Chemical Industries, Ltd.) in lieu of 40 to 60 weight parts of magnesium hydroxide (Kisuma 5B, product of Kyowa Chemical Industry Co.), pelletized thermoplastic resin compositions, 3 mm-thick board-form moldings, and 100 μm-thick sheet-form moldings each having a pressure-sensitive adhesive layer were prepared in the same manner as in Examples 10 to 15.

### EXAMPLES 21 TO 30

The 100 μm-thick sheet-form molding obtained in each of Example 2, 4, 5, 6, 8, 9, 10, 13, 14, or 15 was laminated with a 50 μm-thick sheet molded from a resin composition containing 0.1 to 100 weight parts of the laminar silicate shown in Table 5 in each 100 weight parts of a random type polypropylene resin (Sun-Allomer PC630A, product of Sun-Allomer Co.) as prepared in the same manner as in Example 1 and the assembly was hot-pressed to fabricate a multi-layer sheet molding. Then, on the surface of the sheet-form molding obtained in each of Example 2, 4, 5, 6, 8, 9, 10, 13, 14, or 15, a pressure-sensitive adhesive layer was constructed in the same manner as in Example 1 to manufacture a multi-layer sheet-form molding having a pressure-sensitive adhesive layer.

### COMPARATIVE EXAMPLE 1

To a small extruder (TEX30, manufactured by The Japan Steel Works) were fed 95 weight parts of an ethylene-ethyl acrylate copolymer (DPDJ6182, product of Nippon Unicar Co.), 5 weight parts of a maleic anhydride-modified polyethylene oligomer (ER403A, product of Japan Polyolefins Co.), and 40 weight parts of magnesium hydroxide (Kisuma 5B, product of Kyowa Chemical Industry Co.), and the mixture was melt-kneaded at a temperature setting of 170° C. and extruded into a strand. The strand was pelletized with a pelletizer, and using the pellets thus obtained, a 3 mm-thick board-form molding and a 100 μm-thick sheet-form molding having a pressure-sensitive adhesive layer were fabricated in the same manner as in Example 1.

### COMPARATIVE EXAMPLE 2

To a small extruder (TEX30, manufactured by The Japan Steel Works) were fed 92.3 weight parts of an ethylene-α-olefin copolymer (Karnel KF260, product of Nippon Polychem Co.) and 7.7 weight parts of a non-organic-pretreated swellable fluoromica (Somasif ME-100, product of CO-OP Chemical Co.), and the mixture was melt-kneaded at a temperature setting of 170° C. and extruded into a strand. The strand was pelletized with a pelletizer, and using the pellets thus obtained, a 3 mm-thick board-form molding and a 100 μm-thick sheet-form molding having a pressure-sensitive adhesive layer were fabricated as in Example 1.

### COMPARATIVE EXAMPLE 3

To a small extruder (TEX30, manufactured by The Japan Steel Works) were fed 87.3 weight parts of a polypropylene alloy resin (Adflex KF084S, product of Sun-Allomer Co.), 7.7 weight parts of a organic-pretreated swellable fluoromica (Somasif ME-100, product of CO-OP Chemical Co.), and a two-end diblock type oligomer (CB-OM12, product of Kuraray Co.), and after 120 weight parts of magnesium hydroxide (Magseeds N-4, product of Konoshima Chemical Co.) surface-treated with a metal soap (CS-6, product of Nitto Kasei Co.) in advance was added, the mixture was melt-kneaded at a temperature setting of 170° C. and extruded into a strand. The strand was pelletized with a pelletizer, and using the pellets thus obtained, a 3 mm-thick board-form molding and a 100 μm-thick sheet-form molding having a pressure-sensitive adhesive layer were fabricated in the same manner as in Example 1.

### COMPARATIVE EXAMPLE 4

To a small extruder (TEX30, manufactured by The Japan Steel Works) were fed 50 weight parts of a polypropylene alloy resin (Adflex KF084S, product of Sun-Allomer Co.) and 60 weight parts of a organic-pretreated swellable fluoromica (Somasif ME-100, product of CO-OP Chemical Co.), and the mixture was melt-kneaded at a temperature setting of 170° C. and extruded-into a strand. The strand was pelletized with a pelletizer, and using the pellets thus obtained, a 3 mm-thick board-form molding and a 100 μm-thick sheet-form molding with a pressure-sensitive adhesive layer were fabricated in the same manner as in Example 1.

### COMPARATIVE EXAMPLE 5

To a small extruder (TEX30, manufactured by The Japan Steel Works) were fed 92.3 weight parts of a random type polypropylene resin (Sun-Allomer PC-630A, product of Sun-Allomer Co.) and 7.7 weight parts of calcium carbonate (Calseeds P, product of Konoshima Chemical Co.), and the mixture was melt-kneaded at a temperature setting of 170° C. and extruded into a strand. The strand was pelletized with a pelletizer, and using the pellets thus obtained, a 3 mm-thick board-form molding and a 100 μm-thick sheet-form molding with a pressure-sensitive adhesive layer were fabricated in the same manner as in Example 1.

The mean interlayer distance (1) and percentage of the dispersoid consisting of not more than 5 layers (2) of lamellar silicate in each of the board-form molding obtained in Examples 1 to 20 and Comparative Examples 1 to 5 were determined by the methods described below. In addition, the combustion residue film strength (yield stress) (3), density (4), stress after fracture (5), and elongation after fracture (6) of each of the board-form moldings obtained in Examples 1 to 20 and Comparative Examples 1 to 5 were measured by the methods also described below. Furthermore, the exotherm test parameters (7), gas toxicity (8), 2% modulus (9), elongation after fracture (10), and curved surface compliance (11) of each of the sheet-form molding obtained in Examples 1 to 30 and Comparative Examples 1 to 5 were evaluated by the following methods. The results are presented in Tables 1 to 6.

(1) Mean Interlayer Distance

Using an X-ray diffractometer (RINT1100, manufactured by K. K. Rigaku), 20 of the diffraction pattern obtained from the diffraction of the lamellar surface of the lamellar silicate in the board-form molding was measured and the (001) interplanar spacing (d) of the lamellar silicate was calculated by means of following Bragg relation. The (d) value thus found was regarded as the mean interlayer distance (nm).
λ=2d sin θ
where λ ls 1.54, d represents the interplanar spacing of the lamellar silicate, and θ represents the diffraction angle.
(2) Percentage of the Dispersoid Consisting of Not More than 5 Layers

A specimen was cut out of the board-form molding with a diamond cutter, and based on the transmission electron photomicrogram (JEM-1200 EXII, manufactured by JEOL), the number of layers of lamellar silicate clusters dispersed per unit area was determined and the percentage of the dispersoid consisting of not more than 5 layers was calculated.

(3) Combustion Residue Film Strength (Yield Stress)

In accordance with ASTM E 1354 “Methods for Combustion Test of Architectural Materials”, the board-form molding cut to 100 mm×100 mm (3 mm thick) was combusted by irradiation with heat rays at 50 kW/m² using a cone calorimeter and the combustion residues were compressed at a rate of 0.1 cm/s with a strength meter to measure the combustion residue film strength (yield stress: kPa).

(4) Density

The density (g/cm³) of the board-form molding was measured by the routine method.

(5) Stress After Fracture and (6) Elongation After Fracture

In accordance with JIS K 6301 “Method for Physical Test of Vulcanized Rubber”, a dumbbell No. 3 test piece cut out of the board-form molding was subjected to tensile testing at a pulling speed of 50 mm/minute in an atmosphere controlled at 20° C. and 50% RH to measure the stress after fracture (MPa) and elongation after fracture

(7) Exotherm Test

In accordance with ISO 1182, the sheet-form molding was laminated with a non-combustible material (100×100×12.5 mm, gypsum board) and combusted by heating at 50 kW/m² for 20 minutes. The time during which the maximum exotherm rate would continuously be not less than 200 kW/m² and the total exotherm were measured.

(8) Gas Toxicity Test

In accordance with ISO 1182, the sheet-form molding was laminated with a non-combustible material (220×220×12.5 mm, gypsum board) and heated with LP gas (propane gas, purity not less than 95%) for 3 minutes and, immediately thereafter, further heated with a resistance heater at 1.5 kW for 3 minutes. The combustion gas was guided into a test box housing mice and the mean standstill time of the mice during a 15-minute period immediately following the start of heating was measured. A mean standstill time of 6.8 minutes or longer was regarded as meeting the requirement.

(9) 2% Modulus and (10) Elongation After Fracture

In accordance with JIS K 6734 “Methods for Testing Rigid Polyvinyl Chloride Sheet and Film”, the stress at 2% elongation and elongation after fracture of the sheet-form molding were measured.

(11) Curved Surface Compliance

Using bare hands, a sample of the sheet-form molding was intimately applied against a curved surface compliance-test jig as illustrated in FIG. 1 and the curved surface compliance was organoleptically evaluated according to the following criteria.

[Evaluation Criteria]

◯: Compared with an ornamental pressure-sensitive adhesive sheet (Tack Paint, Product of Sekisui Chemical Co.) which is a decorative sheet made of a polyvinyl chloride resin and having a pressure-sensitive adhesive layer on the reverse side (non-decorative side), the curved surface compliance was fully comparable.

×: The pressure-sensitive adhesive sheet was so poor in flexibility that it could hardly be brought into intimate contact with a curved surface and could not be released as a commercial product.

TABLE 1

| | Example 1 | Example 2 | Example 3 | Example 4 | Example 5 |
|---|---|---|---|---|---|
| Ethylene-ethyl acrylate copolymer | 87.3 | — | — | — | — |
| Ethylene-α-olefin copolymer | — | 87.3 | — | — | — |
| Polypropylene alloy resin | — | — | 87.3 | — | 69.6 |
| Random polypropylene resin | — | — | — | 79.6 | 10 |
| Maleic anhydride-modified ethylene oligomer | 5.0 | 5.0 | 5.0 | — | 5.0 |
| Both-end diblock oligomer | — | — | — | 5.0 | — |
| Organic-pretreated montmorillonite | 7.7 | 7.7 | 7.7 | 15.4 | 15.4 |
| Magnesium hydroxide | 40 | 60 | 10 | 40 | 40 |
| Mean interlayer distance (nm) | ≧3 | ≧3 | ≧3 | ≧3 | ≧3 |
| Percentage of the dispersoid consisting of | 90 | 85 | 90 | 75 | 65 |
| not over 5 layers | | | | | |
| Residual film formation | Formed | Formed | Formed | Formed | Formed |
| Yield stress of residual film (kPa) | 19.0 | 20.0 | 23.0 | 28.0 | 26.0 |
| Density (g/cm³) | 1.12 | 1.14 | 1.08 | 1.16 | 1.18 |
| Stress after fracture (Mpa) | 11.6 | 20.1 | 16.6 | 11.2 | 12.2 |
| Elongation after fracture (%) | 769 | 764 | 780 | 754 | 749 |
| Combustion test: Total exotherm in calories | 7.2 | 7.0 | 8.5 | 6.8 | 6.7 |
| (MJ/m²) | | | | | |
| Exotherm rate not less than 200 kW/m² time (s) | 0 | 2 | 12 | 1 | 1 |
| Gas toxicity test | Acceptable | Acceptable | Acceptable | Acceptable | Acceptable |
| 2% Modulus (N/10 mm) | 7 | 30 | 16 | 15 | 12 |
| Elongation after fracture (%) | 153.8 | 152.8 | 156.0 | 150.8 | 149.8 |
| Curved surface compliance | ◯ | ◯ | ◯ | ◯ | ◯ |

TABLE 2

| | Example 6 | Example 7 | Example 8 | Example 9 | Example 10 |
|---|---|---|---|---|---|
| Ethylene-ethyl acrylate copolymer | 79.6 | — | — | — | — |
| Ethylene-α-olefin copolymer | — | 93.0 | — | — | — |
| Polypropylene alloy resin | — | — | 87.3 | — | 69.6 |
| Random polypropylene resin | — | — | — | 87.3 | 10 |
| Maleic anhydride-modified ethylene oligomer | 5.0 | 5.0 | 5.0 | — | — |
| Both-end diblock oligomer | — | — | — | 5.0 | 5.0 |
| Organic-pretreated swellable fluoromica | 15.4 | 2.0 | 7.7 | 7.7 | 15.4 |
| Magnesium hydroxide | 40 | 40 | 60 | 60 | 40 |
| Mean interlayer distance (nm) | ≧3 | ≧3 | ≧3 | ≧3 | ≧3 |
| Percentage of the dispersoid consisting of | 70 | 95 | 80 | 75 | 80 |
| not over 5 layers | | | | | |
| Residual film formation | Formed | Formed | Formed | Formed | Formed |
| Yield stress of residual film (kPa) | 27.0 | 4.5 | 21.0 | 20.0 | 19.0 |
| Density (g/cm³) | 1.17 | 1.05 | 1.17 | 1.18 | 1.14 |
| Stress after fracture (MPa) | 11.6 | 20.1 | 16.6 | 11.2 | 12.2 |
| Elongation after fracture (%) | 744 | 760 | 734 | 730 | 725 |
| Combustion test: Total exotherm in calories | 7.2 | 8.5 | 6.9 | 6.8 | 6.7 |
| (MJ/m²) | | | | | |
| Exotherm rate not less than 200 kw/m² time (s) | 0 | 11 | 3 | 1 | 1 |
| Gas toxicity test | Acceptable | Acceptable | Acceptable | Acceptable | Acceptable |
| 2% Modulus (N/10 mm) | 26 | 8 | 20 | 15 | 12 |
| Elongation after fracture (%) | 148.8 | 152 | 146.8 | 146 | 145 |
| Curved surface compliance | ◯ | ◯ | ◯ | ◯ | ◯ |

TABLE 3

| | Example 11 | Example 12 | Example 13 | Example 14 | Example 15 |
|---|---|---|---|---|---|
| Ethylene-ethyl acrylate copolymer | 87.3 | — | — | — | — |
| Ethylene-α-olefin copolymer | — | 87.3 | — | — | — |
| Polypropylene alloy resin | — | — | 87.3 | — | 77.3 |
| Random Polypropylene resin | — | — | — | 79.6 | 10 |
| Maleic anhydride-modified ethylene oligomer | 5.0 | 5.0 | 5.0 | — | — |
| Both-end diblock oligomer | — | — | — | 5.0 | 5.0 |
| Organic-pretreated swellable fluoromica | 7.7 | 7.7 | 7.7 | 15.4 | 7.7 |
| Metal soap-treated magnesium hydroxide | 40 | 40 | 40 | 40 | 60 |
| Mean interlayer distance (nm) | ≧3 | ≧3 | ≧3 | ≧3 | ≧3 |
| Percentage of the dispersoid consisting of | 85 | 85 | 80 | 65 | 80 |
| not over 5 layers | | | | | |
| Residual film formation | Formed | Formed | Formed | Formed | Formed |
| Yield stress of residual film (kPa) | 19.0 | 19.0 | 21.0 | 22.0 | 21.0 |
| Density (g/cm³) | 1.14 | 1.14 | 1.16 | 1.16 | 1.17 |
| Stress after fracture (MPa) | 11.6 | 20.1 | 16.6 | 11.2 | 12.2 |
| Elongation after fracture (%) | 700 | 720 | 800 | 500 | 560 |
| Combustion test: Total exotherm in calories | 6.9 | 6.8 | 7.0 | 7.1 | 7 |
| (MJ/m²) | | | | | |
| Exotherm rate not less than 200 kW/m² time (s) | 0 | 2 | 3 | 1 | 1 |
| Gas toxicity test | Acceptable | Acceptable | Acceptable | Acceptable | Acceptable |
| 2% Modulus (N/10 mm) | 7 | 30 | 20 | 15 | 12 |
| Elongation after fracture (%) | 140.0 | 144.0 | 160.0 | 100.0 | 112 |
| Curved surface compliance | ◯ | ◯ | ◯ | ◯ | ◯ |

TABLE 4

| | Example 16 | Example 17 | Example 18 | Example 19 | Example 20 |
|---|---|---|---|---|---|
| Ethylene-ethyl acrylate copolymer | 87.3 | — | — | — | — |
| Ethylene-α-olefin copolymer | — | 87.3 | — | — | — |
| Polypropylene alloy resin | — | — | 87.3 | — | 77.3 |
| Random Polypropylene resin | — | — | — | 79.6 | 10 |
| Maleic anhydride-modified ethylene oligomer | 5.0 | 5.0 | 5.0 | — | — |
| Both-end diblock oligomer | — | — | — | 5.0 | 5.0 |
| Organic-pretreated swellable fluoromica | 7.7 | 7.7 | 7.7 | 15.4 | 7.7 |
| Melamine cyanurate | 10 | 30 | 35 | 25 | 25 |
| Mean interlayer distance (nm) | ≧3 | ≧3 | ≧3 | ≧3 | ≧3 |
| Percentage of the dispersoid consisting of | 80 | 80 | 75 | 60 | 75 |
| not over 5 layers | | | | | |
| Residual film formation | Formed | Formed | Formed | Formed | Formed |
| Yield stress of residual film (kPa) | 18.0 | 17.5 | 16.0 | 19.0 | 17.8 |
| Density (g/cm³) | 1.11 | 1.12 | 1.14 | 1.16 | 1.12 |
| Stress after fracture (MPa) | 12.0 | 13.0 | 11.0 | 17.0 | 12.2 |
| Elongation after fracture (%) | 600 | 620 | 750 | 450 | 660 |
| Combustion test: Total exotherm in calories | 7.0 | 6.4 | 6.8 | 7.0 | 7.9 |
| (MJ/m²) | | | | | |
| Exotherm rate not less than 200 kW/m² time (s) | 0 | 2 | 3 | 1 | 1 |
| Gas toxicity test | Acceptable | Acceptable | Acceptable | Acceptable | Acceptable |
| 2% Modulus (N/10 mm) | 7 | 30 | 20 | 15 | 12 |
| Elongation after fracture (%) | 120 | 124 | 150 | 90 | 132 |
| Curved surface compliance | ◯ | ◯ | ◯ | ◯ | ◯ |

TABLE 5

| | Ex- | Ex- | | | | | | | | |
|---|---|---|---|---|---|---|---|---|---|---|
| | ample | ample | Example | Example | | | | | | |
| | 21 | 22 | 23 | 24 | Example 25 | Example 26 | Example 27 | Example 28 | Example 29 | Example 30 |
| Random | 100 | 100 | 100 | 100 | 100 | 100 | 100 | 100 | 100 | 100 |
| polypropylene | | | | | | | | | | |
| resin | | | | | | | | | | |
| Both-end diblock | — | 5 | 5 | 5 | 5 | — | 5 | 5 | 5 | 5 |
| oligomer | | | | | | | | | | |
| Maleic anhydride- | 5.0 | — | — | — | — | 5.0 | — | — | — | — |
| modified ethylene | | | | | | | | | | |
| oligomer | | | | | | | | | | |
| Organic-pretreated | — | 1 | 2 | — | — | — | 3 | 10 | 10 | 15.4 |
| swellable | | | | | | | | | | |
| fluoromica | | | | | | | | | | |
| Organic-pretreated | 7.7 | — | — | 10 | 15.4 | 7.7 | — | — | — | — |
| montmorillonite | | | | | | | | | | |
| Core-layer sheet- | Ex- | Ex- | Example 5 | Example 6 | Example 8 | Example 9 | Example 10 | Example 13 | Example 14 | Example 15 |
| form molding | ample 2 | ample 4 | | | | | | | | |
| Combustion test: | 7.1 | 7.5 | 7.4 | 7.4 | 6.8 | 6.8 | 6.7 | 7.0 | 7.1 | 7 |
| Total exotherm in | | | | | | | | | | |
| calories (MJ/m²) | | | | | | | | | | |
| Exotherm rate not | 1 | 0 | 2 | 0 | 2 | 1 | 1 | 3 | 1 | 1 |
| less than 200 kw/m² | | | | | | | | | | |
| time (s) | | | | | | | | | | |
| Gas toxicity test | Accept- | Accept- | Accept- | Accept- | Acceptable | Acceptable | Acceptable | Acceptable | Acceptable | Acceptable |
| | able | able | able | able | | | | | | |
| 2% Modulus | 33 | 16 | 15 | 28 | 22 | 16 | 13 | 22 | 16 | 14 |
| (N/10 mm) | | | | | | | | | | |
| Elongation after | 125.0 | 130.0 | 130.0 | 120.0 | 110 | 110.0 | 130.0 | 135.0 | 90.0 | 110 |
| fracture (%) | | | | | | | | | | |
| Curved surface | ◯ | ◯ | ◯ | ◯ | ◯ | ◯ | ◯ | ◯ | ◯ | ◯ |
| compliance | | | | | | | | | | |

TABLE 6

| | Comparative | Comparative | Comparative | Comparative | Comparative |
|---|---|---|---|---|---|
| | Example 1 | Example 2 | Example 3 | Example 4 | Example 5 |
| Ethylene-ethyl acrylate copolymer | 95 | — | — | — | — |
| Ethylene-α-olefin copolymer | — | 100 | — | — | — |
| Polypropylene alloy resin | — | — | 87.3 | 50 | — |
| Random polypropylene resin | — | — | — | — | 92.3 |
| Maleic anhydride-modified ethylene oligomer | 5.0 | — | — | — | — |
| Both-end diblock oligomer | | — | 5.0 | — | — |
| Organic-pretreated swellable fluoromica | — | — | 7.7 | 60 | — |
| Non-organic-pretreated swellable fluoromica | — | 7.7 | — | — | — |
| Calcium carbonate | — | — | — | — | 7.7 |
| Metal soap-treated magnesium hydroxide | 40 | — | 120 | — | — |
| Mean interlayer distance (nm) | — | 2.0 | ≧3 | ≧3 | — |
| Percentage of the dispersoid consisting of | — | 10 | 75 | — | — |
| not over 5 layers | | | | | |
| Residual film formation | Collapse | Collapse | Formed | Formed | Collapse |
| Yield stress of residual film (kPa) | — | 4.5 | 9.0 | 18.0 | — |
| Density (g/cm²) | 1.31 | 1.10 | 1.50 | 1.60 | 1.15 |
| Stress after fracture (MPa) | 8.6 | 8.5 | 2.5 | 16.0 | 12.0 |
| Elongation after fracture (%) | 75 | 120 | ≦5 | 30 | 770 |
| Combustion test: Total exotherm in calories | 8.5 | 12.0 | 6.0 | 7.0 | 12.5 |
| (MJ/m²) | | | | | |
| Exotherm rate not less than 200 kW/m² time (s) | 12 | 22 | 0 | 0 | 25 |
| Gas toxicity test | Acceptable | Acceptable | Acceptable | Acceptable | Acceptable |
| 2% Modulus (N/10 mm) | 2 | 3 | N.D. | 50 | 20 |
| Elongation after fracture (%) | 15 | 24 | ≦5 | 6 | 154 |
| Curved surface compliance | X | ◯ | X | X | ◯ |

### EXAMPLE 31

To a small extruder were fed 90 weight parts of a polypropylene resin (J215W, product of Grand Polymer Co.; density 0.91 g/cm³, MFR 9 g/10 min. (230° C.) and 5 weight parts of a maleic anhydride-modified polyethylene oligomer (ER403A, product of Japan Polyolefins Co.) or 5 weight parts of a two-end dibloc oligomer (CB-OM12, product of Kuraray Co.), and 5 weight parts of swellable fluoromica made hydrophobic with distearyldimethyl(quaternary)ammonium salt (Somasif MAE-100, product of CO-OP Chemical Co.), and the mixture was melt-kneaded at a temperature setting of 190° C. and extruded into a strand. The strand was pelletized with a pelletizer to give a pelletized polypropylene resin composition.

On the other hand, 100 weight parts of a hydrogenated styrene-butadiene-styrene block copolymer (SEBS, Clayton G1657, product of Clayton Polymer Japan Co.) and 50 weight parts of an alicyclic hydrogenated petroleum resin (Arkon P-125, product of Arakawa chemical Industries, Ltd.) were uniformly mix-kneaded to prepare a pressure-sensitive adhesive.

The pelletized polypropylene resin and the pressure-sensitive adhesive were molded into a film (sheet form) by the bilayer coextrusion method to fabricate a masking tape for plating having a base layer thickness of 50 μm and a pressure-sensitive adhesive layer thickness of 10 μm.

### EXAMPLE 32

Except that a polypropylene resin composition for the base layer was prepared using 94 weight parts of a polypropylene resin (J215W, product of Grand Polymer Co.) and 1 weight part of swellable fluoromica (Somasif MAE-100, product of CO-OP Chemical Co.), the procedure of Example 31 was repeated to fabricate a masking tape for plating having a base layer thickness of 40 μm and a pressure-sensitive adhesive layer thickness of 10 μm.

### EXAMPLE 33

Except that the polypropylene resin composition for the base layer was prepared from 75 weight parts of a polypropylene resin (J215W, product of Grand Polymer Co.) and 20 weight parts of swellable fluoromica (Somasif MAE-100, product of CO-OP Chemical Co.), the procedure of Example 31 was repeated to fabricate a masking tape for plating having a base layer thickness of 40 μm and a pressure-sensitive adhesive layer thickness of 10 μm.

### COMPARATIVE EXAMPLE 6

Except that the swellable fluoromica (Somasif MAE-100, product of CO-OP Chemical Co.) was omitted from the polypropylene resin composition for the base layer, the procedure of Example 31 was repeated to fabricate a masking tape for plating having a base layer thickness of 50 μm and a pressure-sensitive adhesive layer thickness of 10 μm.

### COMPARATIVE EXAMPLE 7

Except that the polypropylene resin composition for the base layer was prepared from 99.95 weight parts of a polypropylene resin (J215W, product of Grand Polymer Co.) and 0.05 weight part of swellable fluoromica (Somasif MAE-100, product of CO-OP Chemical Co.), the procedure of Example 31 was repeated to fabricate a masking tape for plating having a base layer thickness of 40 μm and a pressure-sensitive adhesive layer thickness of 10 μm.

The mean interlayer distance, percentage of the dispersoid consisting of not more than 5 layers, and density of each of the masking tape bases obtained in Examples 31 to 33 and Comparative Examples 6 and 7 were measured by the same methods as described above. In addition, the dynamic strength (13) was measured by the following method. The data are presented in Table 7.

(13) Dynamic Strength

A sample for measurement was prepared by cutting the tape to a width of 10 mm and using a chucking interval (distance between chucks) of 40 mm and a pulling speed of 500 m/min, the tensile stress at 5% strain and the elastic modulus in tension were measured in accordance with JIS K 7113.

TABLE 7

| | | | | Comparative | Comparative |
|---|---|---|---|---|---|
| | Example 31 | Example 32 | Example 33 | Example 6 | Example 7 |
| Polypropylene resin | 90 | 94 | 75 | 100 | 94.95 |
| Maleic anhydride-modified ethylene oligomer | 5.0 | — | — | — | 5 |
| Both-end diblock oligomer | — | 5.0 | 5.0 | — | — |
| Organic-pretreated swellable fluoromica | 5 | 1 | 20 | — | 0.05 |
| Mean interlayer distance (nm) | ≧3 | ≧3 | ≧3 | — | ≧3 |
| Percentage of the dispersoid consisting of | 80 | 85 | 75 | — | 80 |
| not over 5 layers | | | | | |
| Density (g/cm³) | 1.06 | 1.02 | 1.16 | 0.91 | 0.94 |
| Elastic modulus in tension (N/mm²) | 49.0 | 39.2 | 53.9 | 29.4 | 34.3 |
| Tensile stress at 5% strain (N/mm²) | 980 | 784 | 980 | 588 | 637 |

It will be apparent from Tables 1 to 4 that in the board-form moldings from the thermoplastic resin compositions obtained in Examples 1 to 20 of the invention, the mean interlayer distance of the lamellar silicate is not less than 3 nm and the number of layers of the dispersoid was not more than 5, with the result that a sintered artifact serving as a fire retardant film was easy to form. Moreover, since the combustion residue film strength (yield stress) values of the board-form moldings from these thermoplastic resin compositions were high, i.e. at least 19 kPa, the film-forming and flame spread-preventive characteristics were excellent. Furthermore, since board-form moldings from these thermoplastic resin compositions had density values not over 1.18 g/cm², the separation from polyvinyl chloride resin was easy. In addition, the boards molded from these thermoplastic resin compositions were not only high in stress after fracture but also high in elongation after fracture and, moreover, were good in the balance of these properties. Furthermore, the pressure-sensitive adhesive sheets fabricated using these sheet-form molding of said thermoplastic resin compositions gave good results in the exotherm test and gas toxicity test and, in addiiton, were satisfactory in 2% modulus, elongation, and curved surface compliance.

It is also apparent from Table 5 that the pressure-sensitive adhesive sheets fabricated by using the multi-layer sheet-form moldings according to Examples 21 to 30 were also as satisfactory as the sheets according to Examples 1 to 20 in the results of the exotherm test and gas toxicity test, as well as in 2% modulus, elongation, and curved surface compliance.

In contrast, the board-form molding not containing a lamellar silicate according to Comparative Example 1 failed to form a combustion residue film so that it was poor in fire retardation and flame-spread prevention. Moreover, its density of 1.31 g/cm³ was close to the density of polyvinyl chloride. Furthermore, this board-form molding was not only poor in stress after fracture but also poor in elongation after fracture. In addition, because the combustion residues of this sheet-form molding did not form a film, the results of the exotherm test and gas toxicity test were unsatisfactory. Furthermore, the sheet-form molding was poor in flexibility and, therefore, poor in curved surface compliance, hence, lacking in practical utility.

It is also apparent from Table 6 that, in Comparative Example 2, no sufficient fire retardation was obtained partly because the interlayer milieu of the fluoromica was not sufficiently expanded and partly because magnesium hydroxide was not added.

In Comparative Example 3, where the level of addition of magnesium hydroxide was excessively high, the dynamic properties (elongation after fracture, in particular) were drastically decreased. Moreover, because the flexibility was impaired, the curved surface compliance was also remarkably poor.

In Comparative Example 4, where the level of addition of swellable fluoromica was too high, the elongation after fracture was decreased and the density was considerably increased, resulting in the loss of flexibility and, hence, a reduction in curved surface compliance.

In Comparative Example 5, where calcium carbonate instead of swollen fluoromica was added, no effective film could be formed, with the result that no combustion control could be obtained.

It is apparent from Table 7 that the masking tapes for plating according to Examples 31 to 33 were invariably satisfactory in the state of dispersion. Since the masking tapes for plating according to Examples 31 to 33 each contains a lamellar silicate in a defined amount in a defined amount of a polypropylene resin and the resulting polypropylene resin composition contains the lamellar silicate dispersed uniformly and microscopically in the polypropylene resin, these tapes can be used advantageously for masking with good dimensional accuracy.

On the other hand, in Comparative Examples 6 and 7, where the lamellar silicate was not formulated at all or formulated only at a low level, resulting the level of addition of fluoromica was not satisfactory the desired dynamic properties and dimensional stability could not be obtained.

### INDUSTRIAL APPLICABILITY

The sheet-form molding according to the present invention is outstanding in fire retardation and flame spread prevention and, particularly because of its form retention during combustion, expresses excellent fire retardancy and flame spread-arresting effects. It accordingly gives decorative sheets and ornamental pressure-sensitive adhesive sheets outstanding in mechanical strength and thermal characteristics.

Furthermore, the decorative sheet or ornamental pressure-sensitive adhesive sheet according to the invention, which is molded from the above-described thermoplastic resin composition, has the above outstanding characteristics and can be used with advantage as a decorative sheet for various uses or as an ornamental pressure-sensitive adhesive sheet.

Moreover, the masking tape for plating according to the present invention has a base layer with high dimensional accuracy as molded from a polypropylene resin composition comprising a defined amount of a laminar silicate uniformly and microscopically dispersed in a defined amount of a polypropylene resin, with the result that it expresses a high degree of application accuracy. Therefore, the masking tape for plating according to the invention can be used with advantage for the masking of non-plating areas of the lead frame metal sheet to be mounted on an electronic component, for instance.

1. (canceled)

2. (canceled)

3. (canceled)

4. (canceled)

5. (canceled)

6. A sheet-form molding comprising a single layer or a plurality of layers,
which has at least one layer consisting essentially of formulating 0.1 to 100 weight parts of a lamellar silicate and 0.1 to 70 weight parts of a metal hydroxide in each 100 weight parts of a thermoplastic resin, and
the lamellar silicate comprises an alkylammonium ion containing not less than 6 carbon atoms.

7. A sheet-form molding comprising a single layer or a plurality of layers,
which has at least one layer consisting essentially of formulating 0.1 to 100 weight parts of a lamellar silicate and 0.1 to 70 weight parts of a metal hydroxide in each 100 weight parts of a thermoplastic resin, and
the lamellar silicate is such that the mean interlayer distance in the (001) plane as measured by wide-angle X-ray diffractometry is not less than 3 nm and that it has been partially or totally dispersed as dispersoid comprising not more than 5 layers.

8. A sheet-form molding comprising a single layer or a plurality of layers,
which has at least one layer consisting essentially of formulating 0.1 to 100 weight parts of a lamellar silicate and 0.1 to 70 weight parts of a metal hydroxide in each 100 weight parts of a thermoplastic resin, and
when, in a combustion test according to ASTM E 1354, it is combusted by heating under a radiant heating condition of 50 kW/m² for 30 minutes and combustion residues are compressed at a rate of 0.1 cm/s, the yield stress is not less than 4.9 kPa.

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. A thermoplastic resin composition consisting essentially of 0.1 to 100 weight parts of a lamellar silicate, and 0.1 to 70 weight parts of a metal hydroxide in each 100 weight parts of a polypropylene alloy resin,
wherein the lamellar silicate is such that the mean interlayer distance in the (001) plane as measured by wide-angle X-ray diffractometry is not less than 3 nm and that it has been partially or totally dispersed as a dispersoid comprising not more than 5 layers and
the polypropylene alloy resin is predominantly composed of a polypropylene resin such that, of the total elution amount in cross fractionation chromatography, the elution amount at temperatures not over 10° C. accounts for 30 to 80 weight % and the elution amount at temperatures over 10° C. up to 70° C. accounts for 5 to 35 weight %.

38. (canceled)

39. (canceled)

40. (canceled)

41. The sheet-form molding according to claim 6,
wherein the thermoplastic resin is a polyolefin resin.

42. The sheet-form molding according to claim 6,
wherein the polyolefin resin is at least one polyolefin resin selected from the group comprising a homopolymer of ethylene, a copolymer of ethylene and an α-olefin other than ethylene and copolymerizable with the ethylene, an ethylene-ethyl acrylate copolymer, an ethylene-vinyl acetate copolymer, a homopolymer of propylene, a copolymer of propylene and an α-olefin other than propylene and copolymerizable with the propylene, and a polypropylene alloy resin.

43. The sheet-form molding according to claim 42,
wherein the polypropylene alloy resin is predominantly composed of a polypropylene resin such that, of the total elution amount in cross fractionation chromatography, the elution amount at temperatures not over 10° C. accounts for 30 to 80 weight % and the elution amount at temperatures over 10° C. up to 70° C. accounts for 5 to 35 weight %.

44. The sheet-form molding according to claim 6,
wherein the lamellar silicate is montmorillonite and/or swellable mica.

45. The sheet-form molding according to claim 6,
wherein when it is laminated with a non-combustible material and combusted under a radiant heating condition of 50 kW/m² in accordance with ISO 1182, the time in which the maximum exotherm rate is continuously not less than 200 kW/m² during a 20-minute period immediately following the start of heating is less than 10 seconds and the total exotherm amount is not over 8 MJ/m², and that it has a thickness of not less than 20 μm.

46. The sheet-form molding according to claim 45,
wherein the mean standstill time of mice is not less than 6.8 minutes in a gas toxicity test in accordance with ISO 1182.

47. The sheet-form molding according to claim 6, which has a density of 0.90 to 1.20 g/cm³.

48. The sheet-form molding according to claim 6, wherein at least one layer thereof is an adhesive/pressure-sensitive adhesive layer.

49. The sheet-form molding according to claim 48,
which has a pigmented layer and a transparent layer.

50. A multi-layer sheet-form molding,
wherein the sheet-form molding according to claim 48 is further provided with a layer containing 0.1 to 100 weight parts of a lamellar silicate in each 100 weight parts of a thermoplastic resin.

51. A decorative sheet,
which comprises the sheet-form molding according to claim 6.

52. The decorative sheet according to claim 51,
which comprises a laminate comprising, reckoning from the face layer side, a transparent film layer, a printed layer, a pigmented film layer, and an adhesive/pressure-sensitive adhesive layer in the order mentioned.

53. The decorative sheet according to claim 51,
elongation after fracture of which is not less than 80% and 2% modulus value of which is 2 to 40 N/10 mm.

54. The decorative sheet according to claim 51,
which is obtainable by calendermolding.

55. The decorative sheet according to claim 54,
wherein the surface of a fire retardant additive is coated with a calendering auxiliary agent.

56. An ornamental pressure-sensitive adhesive sheet,
which comprises the sheet-form molding according to claim 6.

57. The ornamental pressure-sensitive adhesive sheet according to claim 56,
which comprises a laminate comprising, reckoning from the face layer side, a transparent or pigmented transparent film, a pigmented film, and an adhesive/pressure-sensitive adhesive layer in the order mentioned.

58. The ornamental pressure-sensitive adhesive sheet according to claim 56,
elongation after fracture of which is not less than 80% and 2% modulus value of which is 2to 40N/10 mm.

59. The ornamental pressure-sensitive adhesive sheet according to claim 56,
which is obtainable by calendermolding.

60. The ornamental pressure-sensitive adhesive sheet according to claim 59,
wherein the surface of a fire retardant additive is coated with a calendering auxiliary agent.

61. A tape,
which comprises the sheet-form molding according to claim 6.

62. The tape according to claim 61,
wherein, as determined according to JIS K 7113, the tensile stress at 5% strain is not less than 39.2 N/mm² or the tensile modulus of elasticty is not less than 784.0 N/mm².

63. A protect tape,
which comprises the tape according to claim 61.

64. A masking tape for plating,
which comprises the tape according to claim 61.

65. A decorative sheet, which comprises the multi-layer sheet-form molding according to claim 50.

66. An ornamental pressure-sensitive adhesive sheet, which comprises the multi-layer sheet-form molding according to claim 50.

67. A tape, which comprises the multi-layer sheet-form molding according to claim 50.
